(19) United States
(12) Patent Application Publication
(10) Pub. No.: US 2010/0321366 A1
(43) Pub. Date: Dec. 23, 2010

(54) DISPLAY DEVICE AND DRIVING METHOD OF THE SAME

(76) Inventor: Shinichi Hirato, Osaka (JP)

Correspondence Address: NIXON & VANDERHYE, PC, 901 NORTH GLEBE ROAD, 11TH FLOOR, ARLINGTON, VA, 22203, US

(21) Appl. No.: 12/677,196

(22) PCT Filed: Sep. 18, 2008
(86) PCT No.: PCT/JP2008/066881

§ 371 Date: Mar. 9, 2010

(30) Foreign Application Priority Data
Nov. 29, 2007 (JP) 2007-309523

(51) Int. Cl. G09G 3/20; G02F 1/1333

(52) U.S. Cl. 345/211; 349/54; 345/55

(57) ABSTRACT

An active matrix display device includes: pixels (PIX) each of which includes a plurality of subpixels (2A and 2B); and a single field-effect transistor (30) which (i) serves as a selection element (30), and (ii) carries out selection or non-selection with respect to each of the plurality of subpixels (2A and 2B), lengths of a channel forming region which are used as charging/discharging paths for the respective plurality of subpixels (2A and 2B) being caused to be different from each other, by arranging the plurality of subpixels (2A and 2B) so that at least one (2A) of them is connected to a conductive path which branches off and drawn out from the channel forming region of the field-effect transistor (30), and common electrodes (COMA and COMB) being provided for the respective plurality of subpixels (2A and 2B) so as to be electrically separated from each other. This makes it possible to realize (i) a display device which can achieve an easy drive and less number of components, in spite of a single pixel including a plurality of subpixels, and (ii) a driving method of the display device.

### TECHNICAL FIELD

The present invention relates to a display panel having a wide viewing angle characteristic.

### BACKGROUND ART

Patent Literature 1 discloses an MVA liquid crystal display device in which a single pixel includes two subpixels. FIG. 24 illustrates an equivalent circuit of a structure of the pixel. One of the two subpixels is a subpixel 10a, and the other is a subpixel 10b. The subpixel 10a includes a liquid crystal layer 13a and a storage capacitor 22a which are connected to a data signal line 14 via a TFT 16a. The subpixel 10b includes a liquid crystal layer 13b and a storage capacitor 22b which are connected to the data signal line 14 via a TFT 16b. The TFTs 16a and 16b have respective gates which are connected to a scan signal line 12. That is, each of the scan signal line 12 and the data signal line 14 is shared, by the two subpixels 10a and 10b. Moreover, a common electrode 17 is common to both the two subpixels 10a and 10b. The storage capacitor 22a is provided between a pixel electrode 18a and a storage capacitor line 24a. The storage capacitor 22b is provided between a pixel electrode 18b and a storage capacitor line 24b. Thus, the storage capacitor lines are provided for the respective two subpixels 10a and 10b.

FIG. 25 illustrates waveforms (a) through (f) which relate to a driving of the pixel shown in FIG. 24. In FIG. 25, (a) illustrates a waveform of voltage Vs of the data signal line 14, (b) illustrates a waveform of voltage Vcsa of the storage capacitor line 24a, (c) illustrates a waveform of voltage Vcsb of the storage capacitor line 24b, (d) illustrates a waveform of voltage Vg of the scan signal line 12, (e) illustrates a waveform of voltage Vlca of the pixel electrode 18a in the subpixel 10a, and (f) illustrates a waveform of voltage Vlcb of the pixel electrode 18b in the subpixel 10b. In (a) through (f) of FIG. 25, each dashed line represents a waveform of voltage COMMON (Vcom) of the common electrode 17.

As illustrated in (d) of FIG. 25, when the voltage Vg of the scan signal line 12 changes from VgL to VgH at a time T1, the TFTs 16a and 16b are turned ON. During the period between the time T1 and a time T2, in which VgH is kept, data of the voltage Vs whose waveform is illustrated in (a) of FIG. 25 is written to the pixel electrodes 18a and 18b from the data signal line 14. As is clear from (b) and (c) of FIG. 25, the voltages supplied to the respective storage capacitor lines 24a and 24b are controlled, so that the voltages Vcsa and Vcsb are in a relation in which the voltages Vcsa and Vcsb swing, in a pulsed manner, so as to (i) have respective phases reverse to each other with respect to the voltage COMMON and (ii) have positive and negative amplitudes each equal to Vad. As a result, as illustrated by (e) and (f) of FIG. 25, each of the voltage Vlca of the pixel electrode 18a and the voltage Vlcb of the pixel electrode 18b has a voltage drop of Vd due to a feed through phenomenon at the time T2 when a transition occurs from turn-on state to turn-off state in each of the TFTs 16a and 16b. After that, the voltages Vlca and Vlcb swing so as to have respective different voltages.

This causes in Patent Literature 1 the liquid crystal layers of the respective two subpixels 10a and 10b to receive respective different root mean square voltages. This makes it possible to provide a liquid crystal display device for an MVA (Multi-domain Vertical Alignment) drive, which device attains a wide viewing angle characteristic by preventing a grayscale inversion phenomenon, while displaying a white grayscale image, which are recognized when the liquid crystal display device is seen at an oblique angle.

Patent Literature 1

Japanese Patent Application Publication, Tokukai, No. 2004-62146 A (Publication Date: Feb. 26, 2004)

Patent Literature 2

Japanese Patent Application Publication, Tokukai, No. 2006-85204 A (Publication Date: Mar. 30, 2006)

Patent Literature 3

Japanese Patent Application Publication, Tokukaihei, No. 11-109393 A (Publication Date: Apr. 23, 1999)

Patent Literature 4

Japanese Patent Application Publication, Tokukai, No. 2005-316211 A (Publication Date: Nov. 10, 2005)

### SUMMARY OF INVENTION

However, according to FIGS. 24 and 25, it is necessary to provide at least two TFTs (the TFTs 16a and 16b) and two storage capacitor lines (the storage capacitor lines 24a and 24b), in order for the liquid crystal layers of the subpixels in a single pixel to receive different root mean square voltages. Accordingly, such a liquid crystal display device has a problem with a complicated drive due to a large number of components. This may cause an increase in production cost and a decrease in aperture ratio of a pixel. It is not easy to adopt a pixel structure which may cause a low aperture ratio, because there is a demand for having a high aperture ratio, especially in a small-sized panel, etc.

The present invention is accomplished in view of the conventional problems, and its object is to provide (i) a display device which can achieve an easy drive and less number of components, in spite of a single pixel including a plurality of subpixels, and (ii) a driving method of the display device.

In order to attain the object, an active matrix display device of the present invention includes: a pixel which includes a plurality of subpixels; and a single field-effect transistor which (i) serves as a selection element and (ii) carries out selection or non-selection with respect to each of the plurality of subpixels, parts of a channel forming region which are used as charging/discharging paths for the respective plurality of subpixels having lengths different from each other, by arranging the plurality of subpixels so that at least one of them is connected to a conductive path which branches off and is drawn out from the channel forming region of the field-effect transistor, and common electrodes being provided for the respective plurality of subpixels so as to be electrically separated from each other.

According to the configuration, the single field-effect transistor serves as a selection element for supplying data signals to the plurality of subpixels which are included in each of the pixels. The field-effect transistor has the channel forming region whose conductive paths have respective different lengths for each of the subpixels, and the difference in length allows the subpixels to have respective different charging/discharging times. Further, the common electrodes, which are electrically separated from each other, are provided for the respective subpixels. This allows the common voltages to be set in accordance with the charging/discharging response of the subpixels. Accordingly, even when an identical data signal is written into the subpixels, root mean square holding voltages can be differed from subpixel to subpixel. As such, it is possible to obtain a wide viewing angle characteristic while preventing grayscale inversions.

According to the configuration, a pixel requires only a single selection element. Moreover, it is not necessary to cause storage capacitor voltages to differ from subpixel to subpixel.

The configuration described above makes it possible to realize a display device which can achieve an easy drive and less number of components, in spite of a single pixel including a plurality of subpixels.

In order to attain the object, the display device of the present invention further includes a single storage capacitor line which is shared by the plurality of subpixels.

According to the configuration, each of the pixels requires only a single storage capacitor line. This makes it possible to simplify a structure of the pixel.

In order to attain the object, in the display device of the present invention, the common electrodes receive respective different bias voltages which differ between the plurality of subpixels.

According to the configuration, the common electrodes receive respective different bias voltages which differ from subpixel to subpixel. This allows the subpixels to easily have respective different root mean square holding voltages.

In order to attain the object, in the display device of the present invention, timing of supplying a scan signal and timing of supplying a data signal are set so that the plurality of subpixels have respective charging/discharging response times which fall within a period during which a corresponding data signal is written into the pixel.

According to the configuration, the subpixels have charging/discharging response times which are different from each other. Accordingly, by the settings of timings, the charging/discharging response can be ended within the writing period of a data signal. This makes it possible to certainly obtain a target root mean square holding voltage.

In order to attain the object, in the display device of the present invention, the plurality of subpixels are made up of a first subpixel and a second subpixel, and a ratio of a pixel electrode area of the first subpixel to a pixel electrode area of the second subpixel is set to a ratio of one to one.

According to the configuration, the pixel electrodes have an area ratio of one to one, which is a simple integer ratio. The feature is suitable for an MVA mode driving display device in which a slit is provided between pixel electrodes included in a pixel.

In order to attain the object, in the display device of the present invention, the plurality of subpixels are made up of a first subpixel and a second subpixel, and a ratio of a pixel electrode area of the first subpixel to a pixel electrode area of the second subpixel is set to a ratio of one to two.

According to the configuration, the pixel electrodes have an area ratio of one to two, which is a simple integer ratio. The feature is suitable for an MVA mode driving display device in which a slit is provided between pixel electrodes included in a pixel. Moreover, a viewing angle characteristic particularly becomes excellent.

In order to attain the object, in the display device of the present invention, the plurality of subpixels are made up of a first subpixel and a second subpixel, and a ratio of a pixel electrode area of the first subpixel to a pixel electrode area of the second subpixel is set to a ratio of one to three.

According to the configuration, the pixel electrodes have an area ratio of one to three, which is a simple integer ratio. The feature is suitable for an MVA mode driving display device in which a slit is provided between pixel electrodes included in a pixel. Moreover, a viewing angle characteristic particularly becomes excellent.

In order to attain the object, in the display device of the present invention: wires, through which respective bias voltages are supplied to the common electrodes provided for the respective plurality of subpixels, are connected toward a common substrate from a same side on a matrix substrate as a side on which input terminals for lines related to data signals are provided.

According to the configuration, wires can be easily and certainly provided on the common electrode.

In order to attain the object, in the display device of the present invention, the input terminals are made up of first and second input terminals between which a display section is provided; the plurality of subpixels are made up of a first subpixel and a second subpixel, the bias voltages are made up of first and second bias voltages, the common electrodes are made up of first and second common electrodes, and the wires are made up of first and second wires; the first wire through which the first bias voltage is applied to the first common electrode is connected, toward the first common electrode of the first subpixel from a same first side as a side on which the first input terminals of the first line related to the data signal are provided; and the second wire through which the second bias voltage is applied to the second common electrode is connected toward the second second side as a side on which the second input terminals of the second line related to the data signal are provided.

According to the configuration, in a case where two subpixels are provided, wires can be easily and certainly provided on the common electrode.

In order to attain the object, in the display device of the present invention, the second wire (i) is routed around on the matrix substrate from the first side toward the second side, and (ii) is then connected toward the second common electrode.

According to the configuration, in a case where two subpixels are provided, wires can be easily and certainly provided on the common electrode.

In order to attain the object, in the display device of the present invention: respective bias voltages are supplied to the common electrodes provided for the respective plurality of subpixels through wires, at least one of the wires being connected toward a common substrate from a same side on a matrix substrate as a side on which input terminals for lines related to data signals are provided, and the other of the wires being connected toward the common substrate from a same side on the matrix substrate as a side on which input terminals for lines related to scan signals are provided.

According to the configuration, wires can be easily and certainly provided on the common electrode.

In order to attain the object, a driving method of the active matrix type display device of the present invention, the display device includes: a pixel which includes a plurality of subpixels; and a single field-effect transistor which (i) serves as a selection element and (ii) carries out selection or non-selection with respect to each of the plurality of subpixels, parts of a channel forming region which are used as charging/discharging paths for the respective plurality of subpixels having lengths different from each other, by arranging the plurality of subpixels so that at least one of them is connected to a conductive path which branches off and is drawn out from the channel forming region of the field-effect transistor, and common electrodes being provided for the respective plurality of subpixels so as to be electrically separated from each other, said driving method including the step of: supplying bias voltages to the respective common electrodes provided for the respective plurality of subpixels.

According to the configuration, the single field-effect transistor serves as a selection element for supplying data signals to the plurality of subpixels which are included, in each of the pixels. The field-effect transistor has the channel forming region whose conductive paths have lengths different from each other for each of the subpixels, and the difference in length allows the subpixels to have charging/discharging times different from each other. Further, (i) the common electrodes, which are electrically separated from each other, are provided for each of the subpixels and (ii) respective different bias voltages are supplied to the common electrodes. This allows the common voltages to be set in accordance with the charging/discharging response of the subpixels. This makes it possible to cause root mean square holding voltages to be different in accordance with the subpixels even when an identical data signal is written into the subpixels. Accordingly, a wide viewing angle characteristic can be obtained while preventing grayscale inversions.

According to the configuration, a pixel requires only a single selection element. Moreover, it is not necessary to cause storage capacitor voltages to be differed in accordance with each of the subpixels.

The configuration described above makes it possible to realize a driving method of a display device which can achieve an easy drive and less number of components, in spite of a single pixel including a plurality of subpixels.

In order to attain the object, the driving method of the present invention further includes the step of causing storage capacitor voltages corresponding to the respective plurality of subpixels to be equal to each other.

According to the configuration, the storage capacitor voltage can be set to a single pattern. This particularly makes it easy to drive a display device.

In order to attain the object, the driving method of the present invention further includes the step of setting timing of supplying a scan signal and timing of supplying a data signal so that the plurality of subpixels have respective charging/discharging response times which fall within a period during which a corresponding data signal is written into the pixel.

According to the configuration, the subpixels have respective different charging/discharging response times. Accordingly, the charging/discharging response can be ended within the writing period of a data signal, by carrying out the settings of timings. This makes it possible to certainly obtain a target root mean square holding voltage.

In order to attain the object, a source bus line inversion driving is carried out in the driving method of the present invention.

According to the configuration, a display characteristic of liquid crystal can be satisfactorily maintained.

In order to attain the object, a dot inversion driving is carried out in the driving method of the present invention.

According to the configuration, a display characteristic of liquid crystal can be satisfactorily maintained.

For a fuller understanding of the nature and advantages of the invention, reference should be made to the ensuing detailed description taken in conjunction with the accompanying drawings.

### BRIEF DESCRIPTION OF DRAWINGS

FIG. 1

FIG. 1 is a view illustrating one embodiment of the present invention. (a) is a plane view illustrating a structure of a pixel, (b) is an equivalent circuit diagram illustrating the structure of the pixel, and (c) is a cross sectional view illustrating the structure of the pixel.

FIG. 2

FIG. 2 is a graph illustrating a response characteristic of a TFT included in the pixel shown in FIG. 1.

FIG. 3

FIG. 3 is a waveform chart illustrating an action of the pixel shown in FIG. 1.

FIG. 4

FIG. 4 is a graph illustrating response times with respect to source input voltages. (a) shows a conventional case, and (b) shows a case of the present embodiment.

FIG. 5

FIG. 5 is a graph illustrating response characteristics on charging a liquid crystal layer across which positive and negative polar voltages are applied. (a) is a graph illustrating response times on charging for obtaining each grayscale when respective positive and negative polar voltages are applied across a liquid crystal layer, and (b) is a graph illustrating charging times of pixel electrodes via a type A and a type B for obtaining each electrical potential with reference to a common voltage.

FIG. 6

FIG. 6 is a view illustrating viewing characteristics of a liquid crystal display device. (a) is a plane view illustrating a viewing direction, (b) is a graph illustrating a front transmittance characteristics of liquid crystal panels in Examples, and (e) is a graph illustrating a relation between (i) a source input voltage supplied to a source bus line SL and (ii) a gray scale.

FIG. 7

FIG. 7 shows a structure of a pixel in a comparative example of the present invention. (a) is a plane view, and (b) is a cross sectional view taken along the line D-D′ of (a).

FIG. 8

FIG. 8 is a graph illustrating a viewing characteristic of the pixel shown in FIG. 7. (a) illustrates a viewing characteristic in a wide range, and (b) illustrates a viewing characteristic in a part of the range of (a).

FIG. 9

FIG. 9 shows a structure of a first pixel. (a) is a plane view, and (b) is a cross sectional view taken along the line E-E′ of (a).

FIG. 10

FIG. 10 is a graph illustrating a viewing characteristic of the pixel shown in FIG. 9. (a) illustrates a viewing characteristic in a wide range, and (b) illustrates a viewing characteristic in a part of the range of (a).

FIG. 11

FIG. 11 shows a structure of a second pixel. (a) is a plane view, and (b) is a cross sectional view taken along the line F-F′ of (a).

FIG. 12

FIG. 12 shows graphs illustrating a viewing characteristic of the pixel shown in FIG. 11. (a) illustrates a viewing characteristic in a wide range, and (b) illustrates a viewing characteristic in a part of the range of (a).

FIG. 13

FIG. 13 shows a structure of a third pixel. (a) is a plane view, and (b) is a cross sectional view taken along the line G-G′ of (a).

FIG. 14

FIG. 14 shows a graph illustrating a viewing characteristic of the pixel shown in FIG. 13. (a) illustrates a viewing characteristic in a wide range, and (b) illustrates a viewing characteristic in a part of the range of (a).

FIG. 15

FIG. 15 shows a structure of the first pixel. (a) is a plane view of a common electrode pattern, and (b) is a plane view of patterns on a TFT substrate.

FIG. 16

FIG. 16 is a plane view illustrating a first wiring arrangement toward a common electrode.

FIG. 17

FIG. 17 is a plane view illustrating a second wiring arrangement for applying a common voltage to a common electrode.

FIG. 18

FIG. 18 is a plane view illustrating a third wiring arrangement toward a common electrode.

FIG. 19

FIG. 19 is a plane view illustrating connecting arrangements of a common electrode and a wire for applying a common voltage to the common electrode. (a) and (b) are plane views each of which illustrates a pattern at a connecting section of the common electrode and the wire for applying a common voltage.

FIG. 20

FIG. 20 is a waveform chart illustrating waveforms when a source bus line inversion driving is carried out in the liquid crystal display device of the present invention.

FIG. 21

FIG. 21 is a waveform chart illustrating waveforms when a dot inversion driving is carried out in the liquid crystal display device of the present invention.

FIG. 22

FIG. 22 is a block diagram illustrating a structure of a liquid crystal display device according to an embodiment of the present invention.

FIG. 23

FIG. 23 is a view illustrating an arrangement of a television receiver including the liquid crystal display device shown in FIG. 22. (a) is an exploded perspective view of the television receiver, and (b) is a cross sectional view of the liquid crystal display device.

FIG. 24

FIG. 24 is an equivalent circuit diagram illustrating a structure of a pixel made up of two subpixels, according to a conventional technique.

FIG. 25

FIG. 25 is a waveform chart. Each of (a) through (f) illustrates a signal waveform when the pixel shown in FIG. 24 is driven,

### REFERENCE SIGNS LIST

1: Liquid Crystal Display Device (Display Device)

2A: Subpixel (First Subpixel)

2B: Subpixel (Second Subpixel)

30: TFT (Selection Element, Field-effect Transistor)

COMA, COMB, 77, 78, 79, 80, 81, 82, 83, 84, 99A, and 99B: Common Electrode

### DESCRIPTION OF EMBODIMENTS

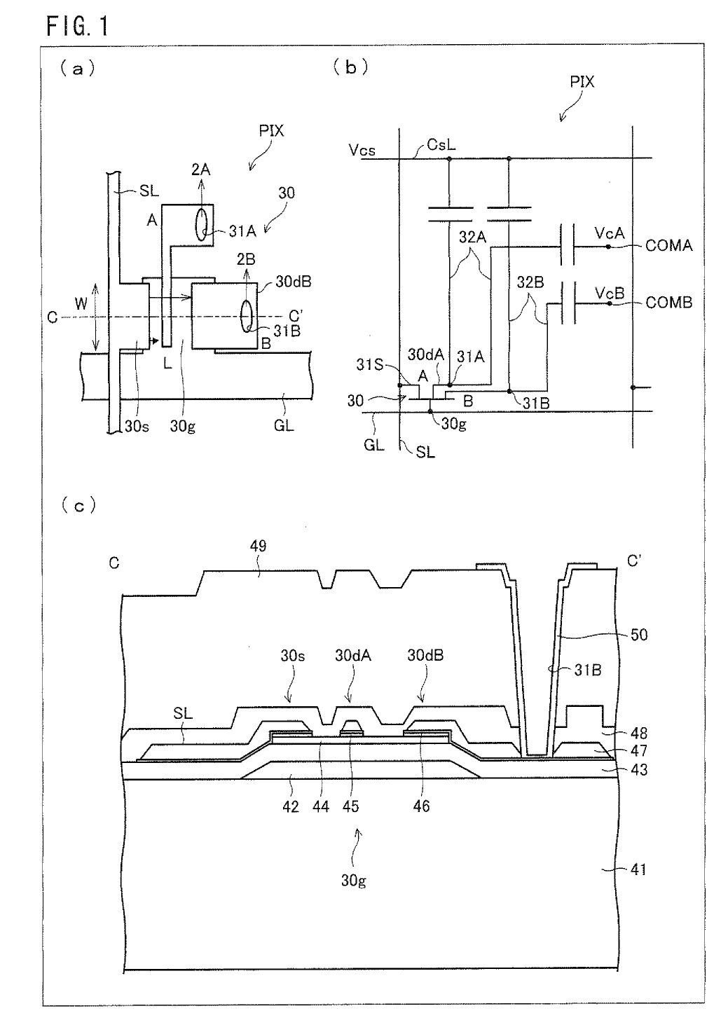

The following describes an embodiment of the present invention with reference to FIGS. 1 through 23.

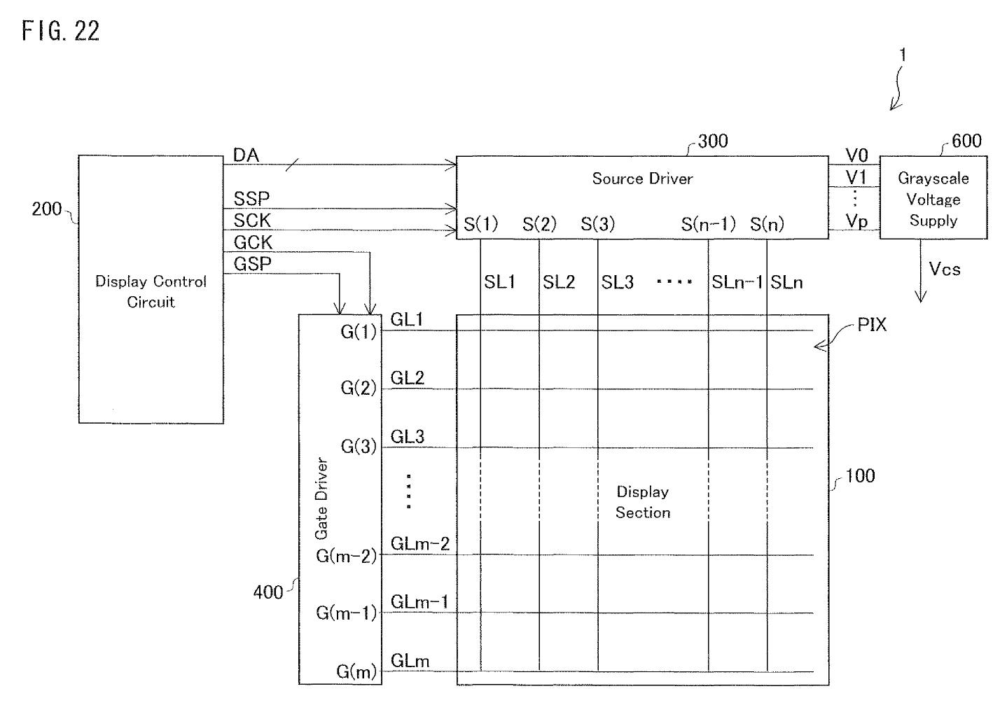

FIG. 22 shows a structure of a liquid crystal display device (display device) 1 in accordance with the present embodiment. The liquid crystal display device 1 includes: a source driver 300 serving as a data signal line driving circuit; a gate driver 400 serving as a scan signal line driving circuit; an active matrix display section 100; a display control circuit 200 which controls the source driver 300 and the gate driver 400; and a grayscale voltage supply 600.

The display section 100 includes: a plurality of gate bus lines GL1 through GLm (m lines) each serving as a scan signal line; a plurality of source bus lines SL1 through SLn (n lines) each serving as a data signal line; and a plurality of pixels PIX (m×n pixels). The plurality of gate bus lines GL1 through GLm intersect the plurality of source bus lines SL1 through SLn, and the plurality of pixels PIX are provided at respective intersections of the gate bus lines GL1 through GLm and the source bus lines SL1 through SLn. The plurality of pixels PIX are arranged in a matrix manner, so as to form a pixel array. Each of the plurality of pixels PIX includes a plurality of subpixels each of which is subjected to an MVA drive, which will be described later with reference to (a) through (c) of FIG. 1 Moreover, a storage capacitor bus line CsL is provided, in each of the plurality of pixels, between any two adjacent gate bus lines GL, which will be described later with reference to (b) of FIG. 1.

The display control circuit 200 supplies (i) a source start pulse signal SSP, a source clock signal SCK, and display data DA to the source driver 300, and (ii) a gate start pulse signal GSP and a gate clock signal GCK to the gate driver 400.

The source driver 300 sequentially generates data signals S(1) through S(n) for each of horizontal scanning periods in accordance with the display data DA, the source start pulse signal SSP, and the source clock signal SCK. Then, the data signals S(1) through S(n) are supplied via the source bus lines SL1 through SLn, respectively. The grayscale voltage supply 600 (i) generates voltages V0 through Vp as grayscale reference voltages which are used for selecting the data signals S(1) through S(n), and then (ii) supplies the voltages VO through Vp to the source driver 300. Further, the grayscale voltage supply 600 generates and supplies a storage capacitor voltage Vcs.

The gate driver 400 (1) generates gate signals for writing the respective data signals S(1) through S(n) into the respective pixels PIX (respective pixel capacitors) in accordance with the gate start pulse signal GSP and the gate clock signal GCK and (ii) sequentially selects gate bus lines GL1 through GLm for substantially each horizontal scanning period in each frame period.

Note that a plurality of source drivers 300 can be provided on a plurality of sides of the display section 100 so that the display section 100 is arranged between them. Similarly, a plurality of gate drivers 400 can be provided on a plurality of sides of the display section 100. This arrangement is suitable for driving the display section 100 which is divided into a plurality of regions.

Each of the plurality of pixels PIX includes a TFT (selection element, field-effect transistor) 30, a liquid crystal capacitor Clc, and a storage capacitor Ccs. The TFT 30 has a gate (conduction control terminal), a source, and a drain, which are connected to the gate bus line GL, the source bus line SL, and the pixel electrode, respectively. The liquid crystal capacitor Clc is defined by the pixel electrode, the common electrode, and the liquid crystal layer provided between the pixel electrode and the common electrode. A common voltage (bias voltage) Vcom is applied to the common electrode. The storage capacitor Ccs is provided between the pixel electrode and the storage capacitor bus line CsL. A storage capacitor voltage Vcs is applied to the storage capacitor bus line CsL.

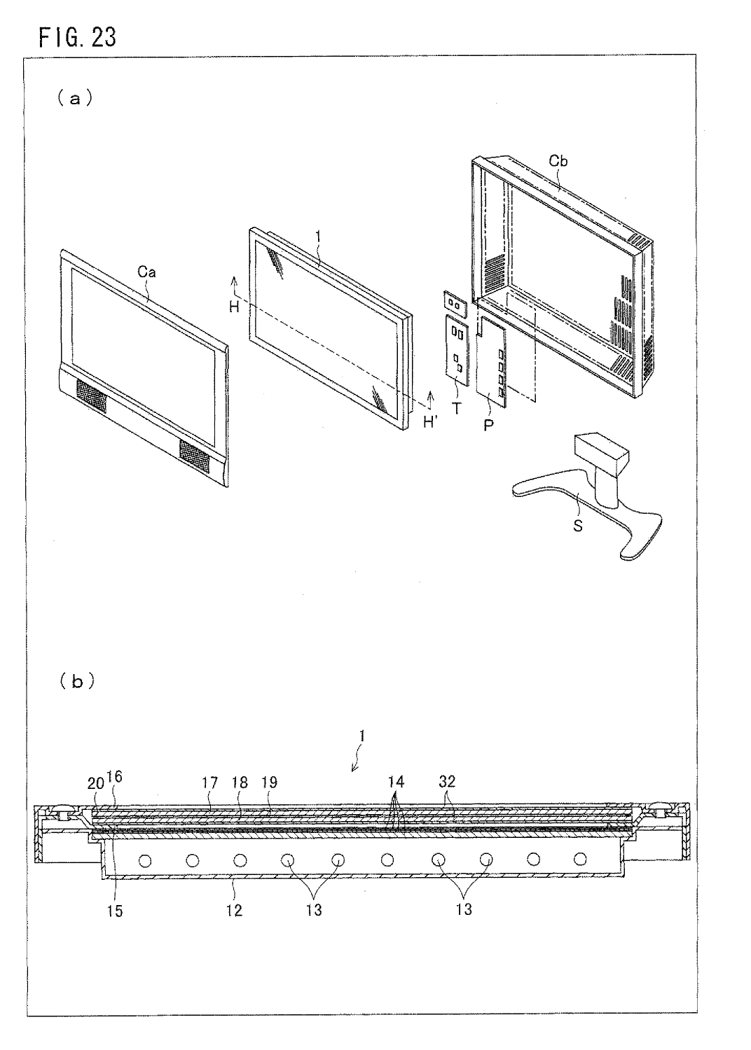

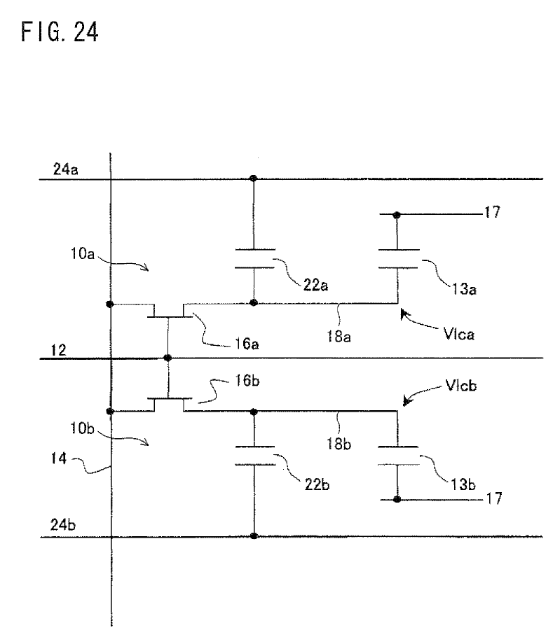

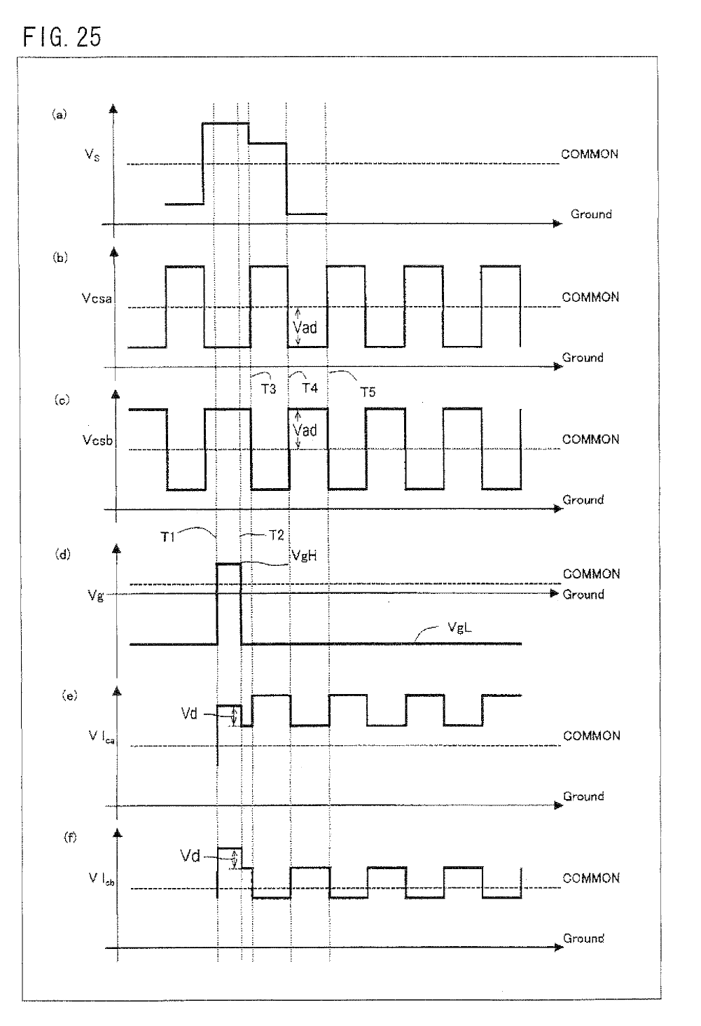

The liquid crystal display device 1, which substantially has an oblong rectangular shape, includes a liquid crystal panel and a backlight. The liquid crystal panel can display an image, and includes a display section 100, a source driver 300, a gate driver 400, and a grayscale voltage source 600. The backlight serving as an external light source (illuminating device) is provided behind the liquid crystal panel, and can irradiate the liquid crystal panel with light. The liquid crystal display device 1 is applicable to a television receiver. As shown in (a) of FIG. 23, the television receiver includes the liquid crystal display device 1, front and rear cabinets Ca and Cb provided so as to contain the liquid crystal display device 1 between them, a power supply P, a tuner T for receiving broadcast such as television broadcast, and a base S.

As shown in (b) of FIG. 23, the backlight includes: a case 12 which is substantially box-shaped and has an opening in its front side (the liquid crystal side); a plurality of line sources 13, such as cold-cathode tubes, which are contained in the case 12 while being aligned in parallel; a plurality of optical members 14, stacked over the opening of the case 12, such, as a diffusing plate, a diffusing sheet, a lens sheet, and a luminance enhancing sheet which are stacked in this order from the bottom side of the case 12; and a frame 15 for causing the plurality of optical members 14 to be held between the frame 15 and the case 12. The plurality of optical members have functions such as a function of converting light emitted from the line sources 13 into planar light. The frame 15 serves as a supporting member which supports the liquid crystal panel from the backside of the liquid crystal panel. A frame-shaped bezel 16 (presser member) presses the liquid crystal panel from a front side of the liquid crystal panel so that the liquid crystal panel is held between the bezel 16 and the frame 15.

The liquid crystal panel includes: a pair of transparent (having translucency) glass substrates 17 and 18, each of which has an oblong rectangular shape; a liquid crystal layer 19, provided between the substrates 17 and 18, which contains liquid crystal molecules whose optical characteristics change in accordance with an applied electric field; and a frame shaped sealing section 20 which (i) is provided between the substrates 17 and 18 and (ii) end-seals the liquid crystal layer 19 by surrounding the liquid crystal layer 19. The substrates 17 and 18 are combined so as to face with each other while maintaining a certain gap (distance) therebetween. A plurality of spacers are dispersed in the liquid crystal layer 19 so as to maintain the gap between the substrates 17 and 18. The spacers are made of (i) an organic material such as a phenol resin or an epoxy resin or (ii) an inorganic material such as silica. The spacers are provided on the gate bus line GL (i.e., in a light-shielding region) of the array substrate 18.

The following describes a structure of a pixel PIX with reference to (a) through (c) of FIG. 1.

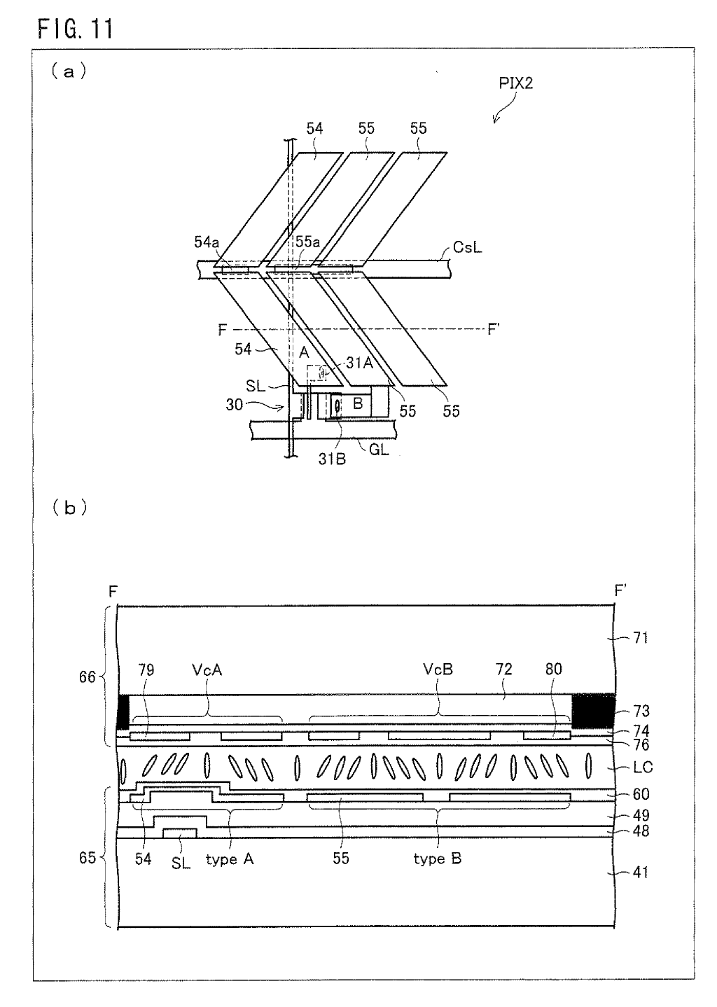

As shown in (a) of FIG. 1, the pixel PIX includes a single TFT 30. The TFT 30 is provided around an intersection of a gate bus line GL and a source bus line SL. The TFT 30 has (i) a gate 30g which is connected to the gate bus line GL and (ii) a source 30s which is connected to the source bus line SL. A channel forming region is provided between a drain 30dB and the source 30s. A drain 30dA branches off from the channel forming region. The drain 30dA has a pulled-out pad which is connected to a subpixel 2A (not illustrated) via a contact hole 31A formed in the pulled-out pad. The drain 30dB has a pulled-out pad which is connected to a subpixel 2B (not illustrated) via a contact hole 31B formed in the pulled-out pad. Specific structures of the subpixels 2A and 2B are described later with reference to FIGS. 11, 13, and 15. As described above, according to the present embodiment, the single pixel PIX includes the single TFT 30, and the drain branches off from the channel forming region of the TFT 30. This makes it possible to attain a function as if two different TFTs were operated. That is, according to the TFT 30, (i) a gate length L of a part A which is connected to the subpixel 2A is shorter than that of a part B which is connected to the subpixel 2B, and (ii) the part A and the part B have an identical gate width W. Table 1 shows specific dimensions and physical values of the parts A and B of the TFT 30.

TABLE 1

| | A | B |
|---|---|---|
| Mobility μ [m²/V] | 3.60E−05 | 3.60E−05 |
| Capacity of gate insulating | 9.71E−05 | 9.71E−05 |
| film [F/m²] | | |
| Dielectric constant of gate | 3.40E−11 | 3.40E−11 |
| insulating film ∈ [F/m] | | |
| Film thickness of gate | 3.50E−07 | 3.50E−07 |
| insulating film t [m] | | |
| Threshold voltage Vth [V] | 2.835165 | 2.821918 |
| Gate width W [m] | 4.00E−05 | 4.00E−05 |
| Gate length L [m] | 4.00E−06 | 1.40E−05 |

(b) of FIG. 1 is an equivalent circuit diagram of the pixel PIX. The pixel PIX includes two subpixels 2A and 2B in addition to the TFT 30. The subpixel (first subpixel) 2A includes a liquid crystal capacitor ClcA and a storage capacitor CcsA, and the subpixel (second subpixel) 2B includes a liquid crystal capacitor ClcB and a storage capacitor CcsB.

In the subpixel 2A, the liquid crystal capacitor ClcA is a capacitor defined by a pixel electrode 32A, a common electrode COMA, and a liquid crystal layer arranged between the pixel electrode 32A and the common electrode COMA. The storage capacitor CcsA is a capacitor which is formed between the pixel electrode 32A and a storage capacitor bus line CsL. In the subpixel 2B, the liquid crystal capacitor ClcB is a capacitor defined by a pixel electrode 32B, a common electrode COMB, and a liquid crystal layer arranged between the pixel electrode 32B and the common electrode COMB. The storage capacitor CcsB is a capacitor which is formed between the pixel electrode 32B and a storage capacitor bus line CsL.

The pixel electrode 32A is connected to the drain 30dA of the TFT 30 via the contact hole 31A. The pixel electrode 32B is connected to the drain 30dB of the TFT 30 via the contact hole 31B. The common electrode COMA receives a common voltage VcA, and the common electrode COMB receives a common voltage VcB. The storage capacitor bus line CsL receives a storage capacitor voltage Ves.

As described above, according to the present embodiment, common electrodes are provided for the respective subpixels, whereas a storage capacitor bus line shared by all subpixels. (c) of FIG. 1 illustrates an example of a cross sectional structure of the TFT substrate taken along the line C-C′ of (a) of FIG. 1.

A gate metal 42, in which Ti, Al, and TiN are stacked, is provided on a glass substrate 41. The gate metal 42 is covered with a gate insulating film 43 made of SiNx or SiOx. An i-layer 45 of Si which serves as a semiconductor layer is provided above the gate insulating film 43 and above the gate metal 42. The i-layer 45 is covered with an n⁺-layer 46 of Si serving as an ohmic-contact layer. The n⁺-layer 46 is covered with a source lower-layer metal 46 made of Ti and a source upper-layer metal 47 made of Al in this order. The source lower-layer metal 46 and the source upper-layer metal 47 cover the source bus line SL, the source 30s of the TFT 30, the drain 30dA of the TFT 30, and the drain 30dB of the TFT 30.

Further, the above stacked layers are covered with (i) a passivation film 48 made of SiNx or SiOx and (ii) a transparent insulating film (JAS) 49 in this order. The contact hole 31B is penetrating through the passivation film 48 and the transparent insulating film 49 at an area (i) which is above the pulled-out pad of the drain 30dB and (ii) in which the source metal lower-layer 47 is exposed. An inner wall of the contact hole 31B and the transparent insulating film 49 are coated with a transparent conductive film 50 made of ITO or ZnO. The transparent conductive film 50 constitutes the pixel electrode 32B of the subpixel 2B.

The following describes an operation of the TFT 30 of the pixel FIX having the structure.

In general, a drain current I_{DS} of a TFT is represented by Formula 1 in an unsaturated region, and by Formula 2 in a saturated region, with use of the physical values in Table 1.

$$\begin{matrix}{I}_{DS} = μ {C}_{GI} \frac{W}{L} ( ( {V}_{GS} - {V}_{th} ) {V}_{DS} - \frac{1}{2} {V}_{DS}^{2} ) & [ Formula 1 ] \\ {I}_{DS} = \frac{1}{2} μ {C}_{GI} \frac{W}{L} {( {V}_{GS} - {V}_{th} )}^{2} & [ Formula 2 ]\end{matrix}$$

Note that V_{GS} represents a voltage between a gate and a source, V_{DS} represents a voltage between a drain and the source, and C_{GI}=ε/t.

Formula 3 and Formula 4 represent charging responses of a pixel in case of the drain currents represented by Formula 1 and Formula 2, respectively.

$$\begin{matrix}τ = \frac{{L}^{2}}{μ ( {V}_{GS} - {V}_{DS} )} & [ Formula 3 ] \\ τ = \frac{{L}^{2}}{μ {V}_{DS}} & [ Formula 4 ]\end{matrix}$$

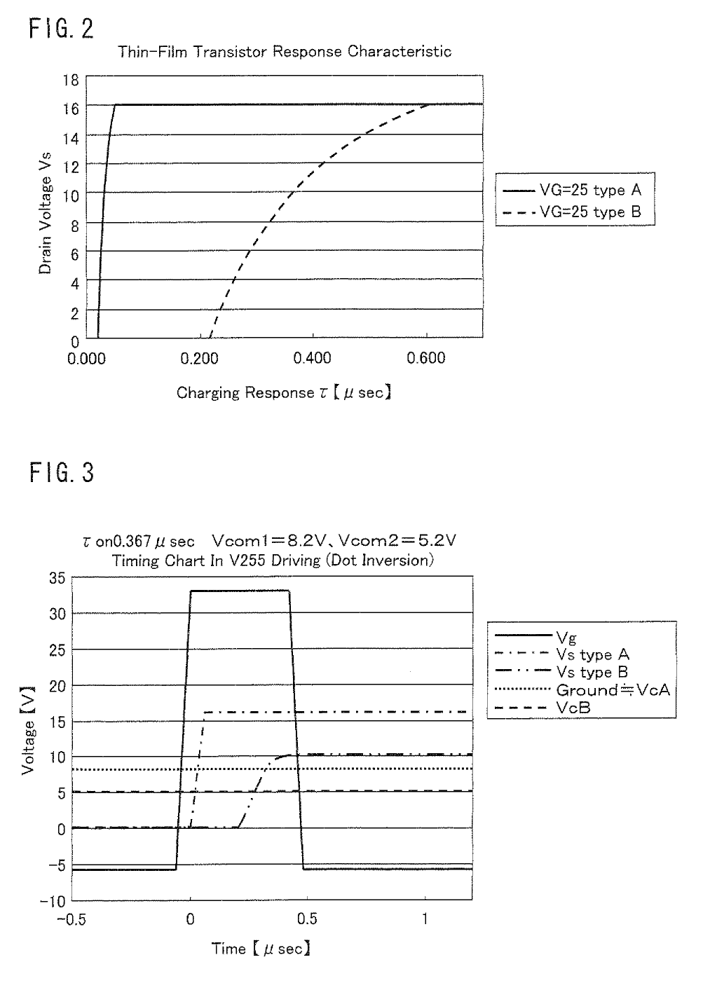

FIG. 2 illustrates responses of TFT obtained when a gate voltage VG is 25 V, based on Formulae 1 through 4. In a case where a charging path via the part A of TFT 30 is represented by a type A and a charging path via the part B of TFT 30 is represented by a type B, the type A is charged faster than the type B. Accordingly, for example, in a case where a voltage Vs of the drain 30dB in the type B (i.e., a voltage of the pixel electrode 32B) is increased up to 30V, it takes a charging response time (see a dashed line in FIG. 2). In this case, charging is already completed in the type A, and a voltage of the drain 30dA (i.e., a voltage of the pixel electrode 32A) is 16V. This is shown in FIG. 3 which is a waveform chart. Note, however, that (i) a high voltage of a scan voltage Vg is different from that of FIG. 2 and (ii) a common voltage VcA of the type A is a ground voltage (constant voltage) and a common voltage VcB of the type B is 5V (constant voltage). A storage capacitor voltage Vcs can be either constant or can be changed periodically. The subpixels 2A and 2B are charged while a scan voltage Vg is being in a high voltage. A drain voltage (a voltage of a pixel electrode) Vs is changed up to 16 V in case of the type A or 30 V in case of the type B. This causes the liquid crystal layers of the respective subpixels 2A and 2B to receive respective root mean square voltages different from each other so that the subpixels 2A and 2B have luminance different from each other. As such, it is possible to realize a wide viewing angle characteristic while preventing a grayscale inversion.

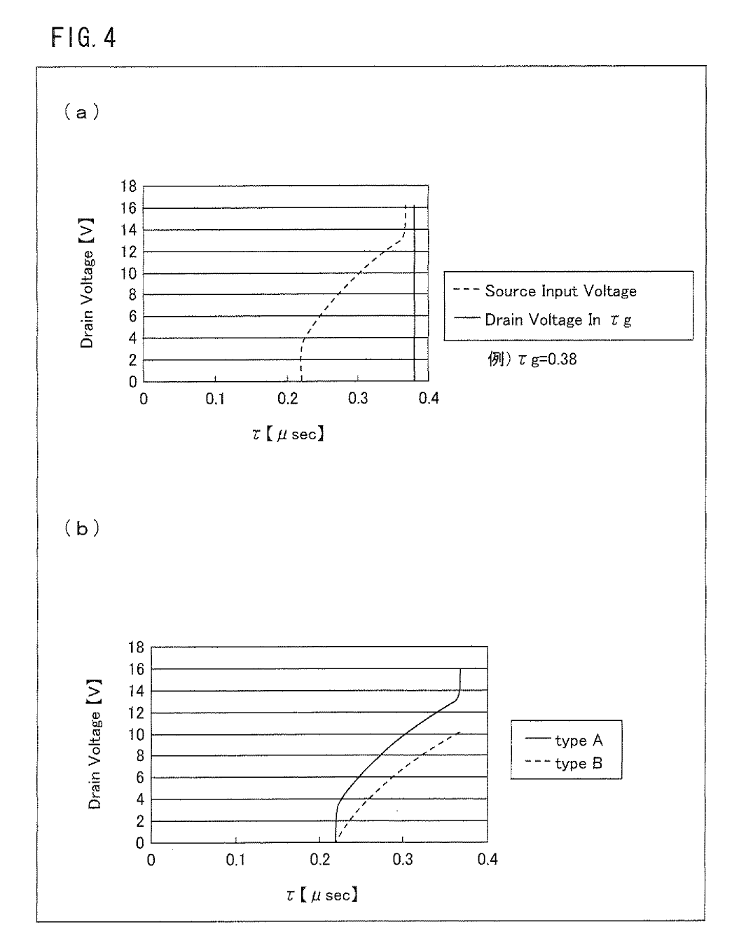

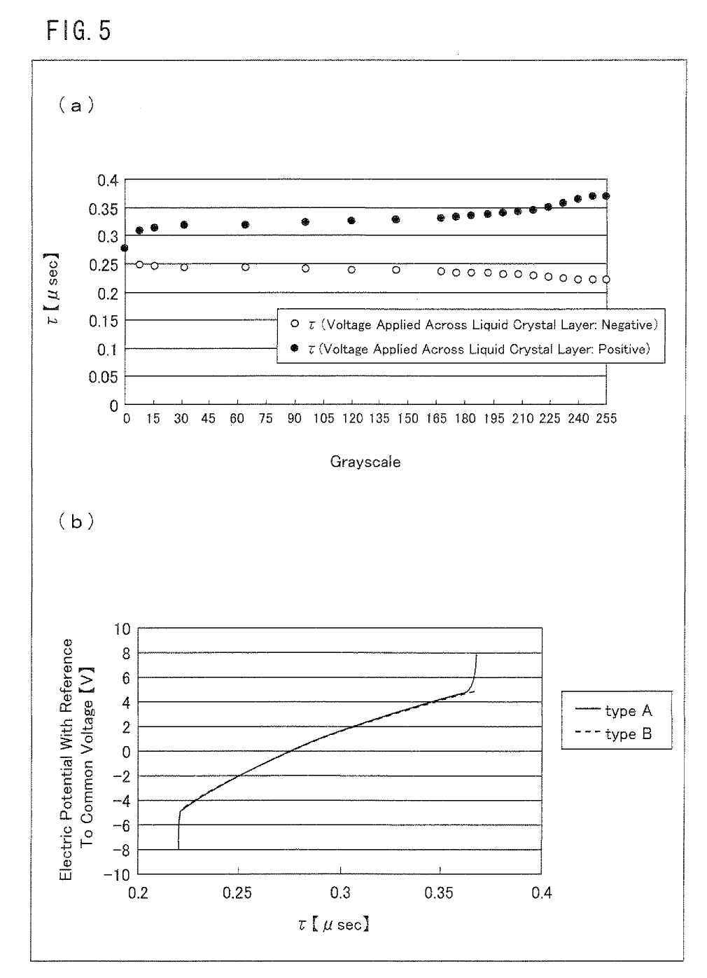

In a conventional technique, a plurality of subpixels have a single charging response time τg, in response to a same source input voltage, which was uniquely set as a charging response time τ for a target drain voltage (see (a) of FIG. 4). In contrast, according to the present embodiment, a plurality of subpixels have respective different charging response times in response to a same source input voltage (see curved lines of the respective types A and B shown in (b) of FIG. 4). (a) of FIG. 5 shows examples of respective response times on charging for obtaining each gray scale required (i.e., an example of times required for inputting of a same source signal to a plurality of subpixels to be completed) when a voltage having a positive or negative polarity is applied across the liquid crystal layer of the present embodiment. (b) of FIG. 5 illustrates examples of charging times of the respective types A and B for obtaining each electric potential with reference to a common voltage of a pixel electrode.

As described above, according to the present embodiment, each pixel includes a plurality of subpixels, and a data signal is supplied to the plurality of subpixels with the use of a single field-effect transistor serving as a selection element. In the channel forming region of the field-effect transistor, the plurality of subpixels have respective different conduction paths. The respective different conduction paths cause the subpixels to have different charging/discharging times. The common electrode is electrically separated for the respective plurality of subpixels. Accordingly, common voltages can be set so as to correspond to charging/discharging responses of the respective plurality of subpixels. This allows the plurality of subpixels to receive respective different root mean square holding voltages, even in a case where an identical data signal is written into the plurality of subpixels. As such, it is possible to realize a wide viewing angle characteristic while preventing a grayscale inversion.

According to the present embodiment, (i) a single selection element is merely required for a pixel and (ii) it is not necessary for the plurality of subpixels to receive respective different storage capacitor voltages.

The configuration described above makes it possible to realize a display device which can achieve an easy drive and less number of components, in spite of a single pixel including a plurality of subpixels.

The following describes a viewing characteristic of the liquid crystal display device 1 according to the present embodiment.

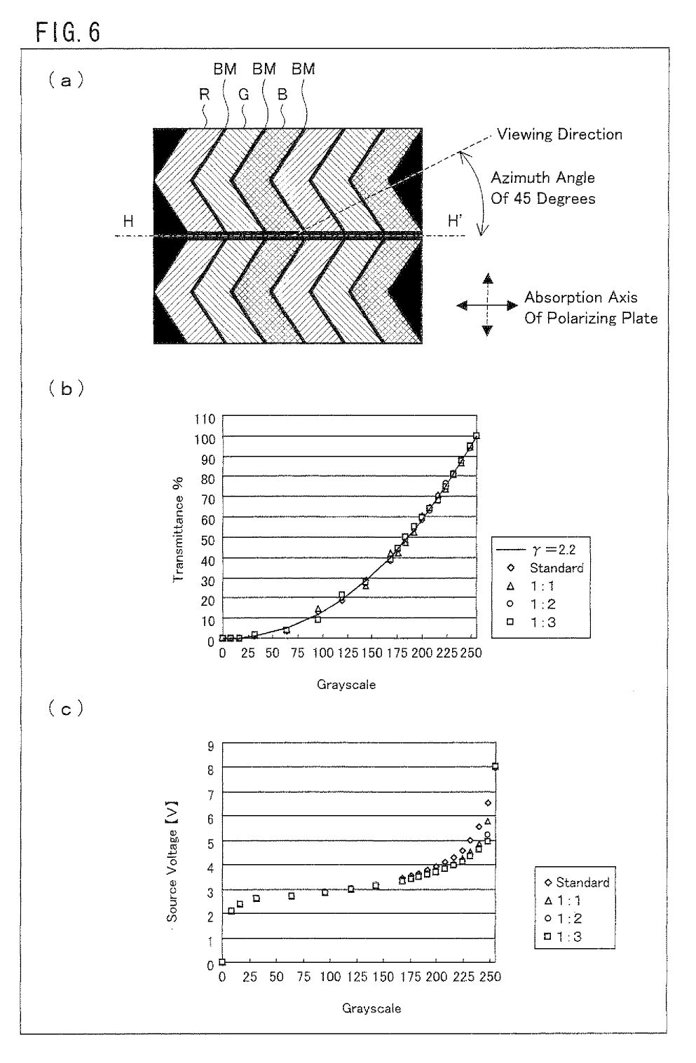

As shown in (a) of FIG. 6, the liquid crystal panel is an. MVA mode liquid crystal panel which includes a display section 100 whose liquid crystal molecules are tilted while a voltage is being supplied to the molecules, in four directions at angles of 45 degrees, 135 degrees, 225 degrees, and 315 degrees with respect to an absorption axis of a polarizing plate. A viewing direction is at an azimuth angle of 45 degrees. A direction of the absorption axis of each polarizing plate is conformed to (i) a horizontal direction H-H′ of the liquid crystal display device 1 (see FIG. 23) or (ii) a direction perpendicular to the horizontal direction H-H′. Each of pixels R, G, and B in the MVA mode liquid crystal panel has an indented shape by taking into consideration the four directions. The pixels R, G, and B are arranged so as to be adjacent, in this order, to each other in the direction H-H′. A black matrix BM is provided between color filters for the respective pixels R, G, and B so as to avoid color mixtures. In the following comparative example and Examples, each liquid crystal panel is arranged so as to have a front transmittance whose gamma characteristic γ is 2.2. In (b) of FIG. 6, “Standard” corresponds to the comparative example, “1:1” corresponds to Example 1, “1:2” corresponds to Example 2, and “1:3” corresponds to Example 3. (c) of FIG. 6 illustrates a relation, in each of the comparative example and Examples, between respective gray scales and respective source input voltages supplied via the source bus line SL.

The following describes evaluation results of the pixel structures and their viewing characteristics of the comparative example and Examples.

### Comparative Example

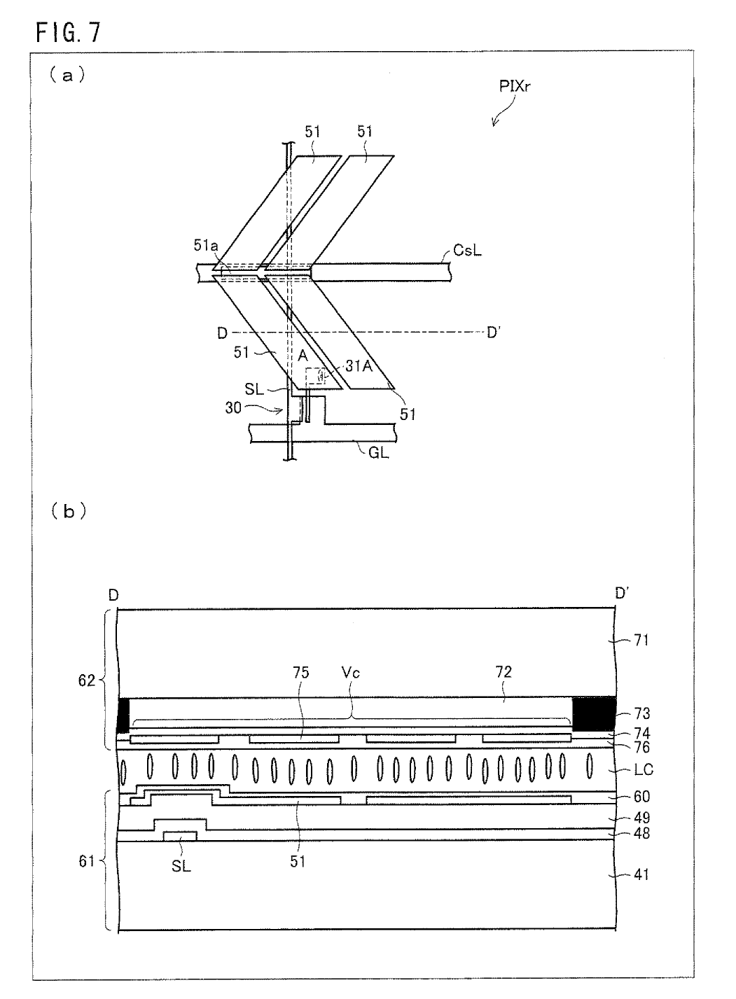

(a) of FIG. 7 is a plane view illustrating a schematic structure of a pixel PIXr which is a comparative example with respect to Examples described later. The pixel PIXr is different from the pixel PIX shown in (a) of FIG. 1 in that the pixel PIXr does not include a charging path of the type B and includes a plurality of pixel electrodes 51 which belong to the type A. The plurality of pixel electrodes 51 are provided so that a slit is provided between respective ones of the plurality of pixel electrodes 51 which ones are adjacent to each other in a line direction. The slits extend so as to be at an angle of 45 degrees for MVA driving use. The plurality of pixel electrodes 51 are connected with each other via a connecting electrode 51a above a storage electrode bus line CsL. Accordingly, the pixel PIXr does not include any subpixel. One of the plurality of pixel electrodes 51 is connected to the TFT 30 via a contact hole 31A. Note that only a single common electrode, which has a slit, is provided. Accordingly, both a TFT substrate and a common substrate are driven in accordance with a PVA (Patterned Vertical Alignment) mode which is an MVA mode utilizing a slit electric field.

(b) of FIG. 7 is a cross sectional view of the pixel PIXr taken along the line D-D′ of (a) of FIG. 7.

The pixel PIXr has an arrangement in which a VA liquid crystal layer LC is provided between a TFT substrate 61 and a common substrate 62. The TFT substrate 61 is arranged so that (i) a pixel electrode 51 made of a transparent electrode and (ii) a VA alignment film 60 are provided, in this order, on the transparent insulating film 49 shown in (c) of FIG. 1. The common substrate 62 is arranged so that (i) a color filter 72 and a black matrix 73, (ii) a passivation film 74, (iii) a common electrode 75 made of a transparent electrode, and (iv) a VA alignment film 76 are provided, in this order, on a glass substrate 71. The common electrode 75 receives a common voltage Vc.

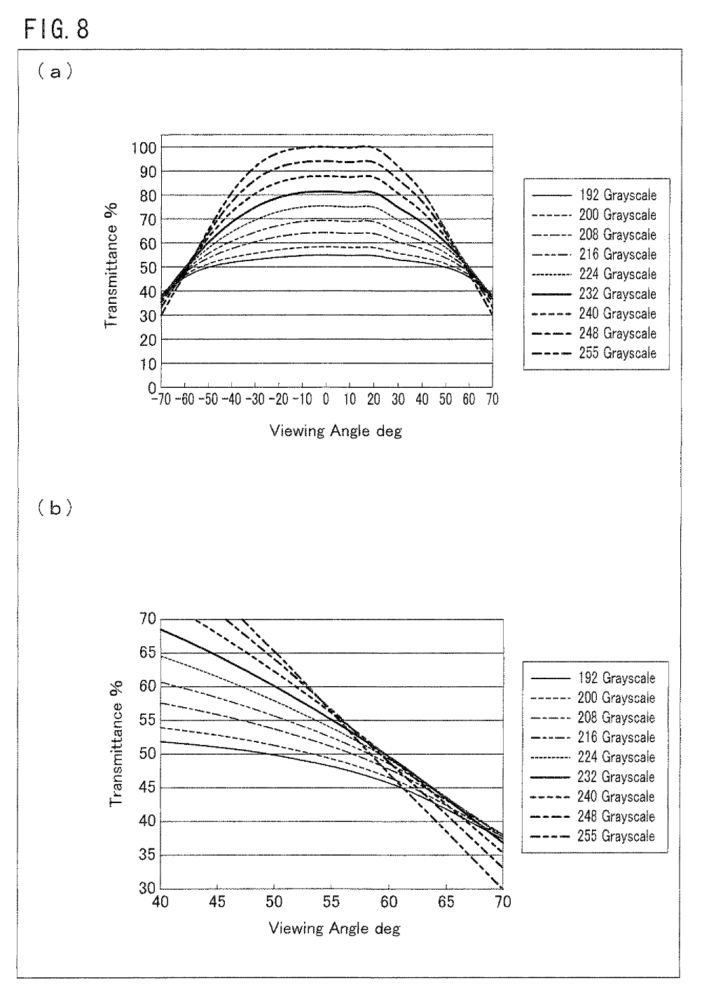

(a) of FIG. 8 illustrates a transmittance characteristic of the pixel PIXr viewed in a direction which is at an azimuth angle of 45 degrees with the line direction. (b) of FIG. 8 is a magnified graph illustrating the transmittance characteristics each in a range of viewing angles from 40 degrees to 70 degrees at the azimuth angle. (b) of FIG. 8 shows that large grayscale inversions occur at viewing angles which are short of around 60 degrees and more.

### Example 1

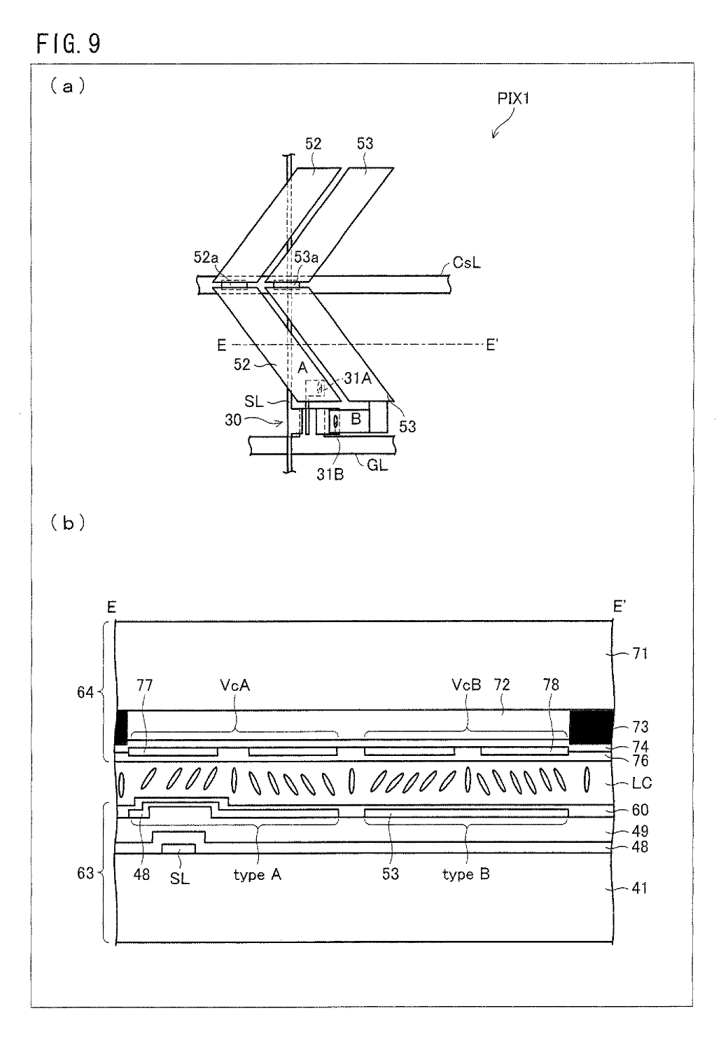

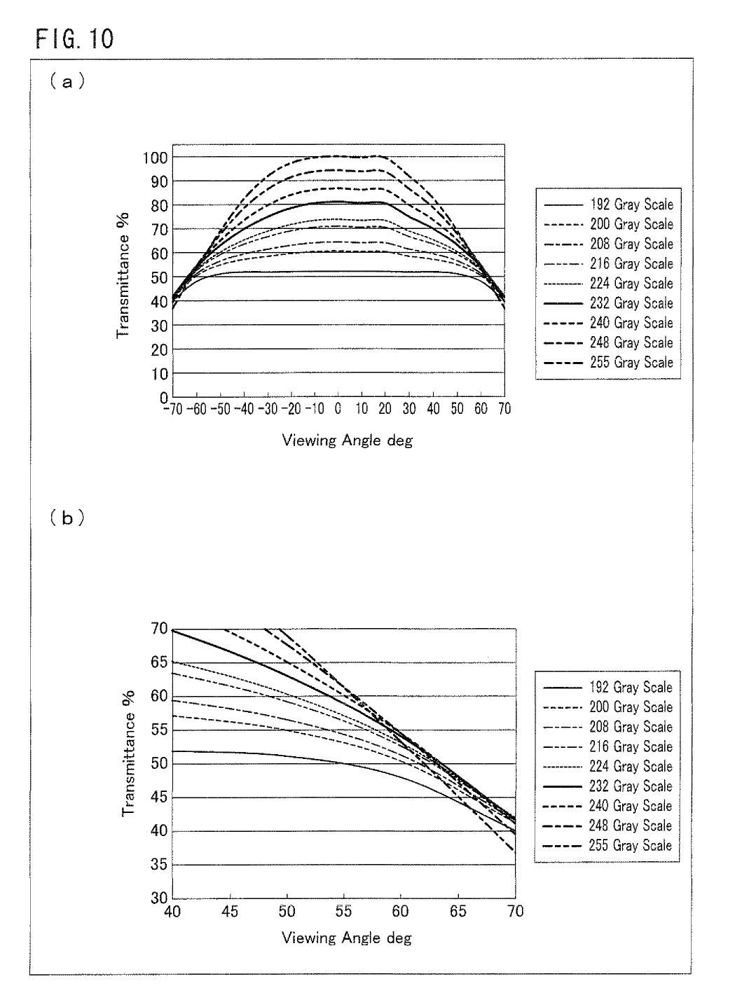

(a) of FIG. 9 is a plane view illustrating a schematic structure of a pixel PIX1 which is an example of the pixel PIX. The pixel PIX1 is different from the pixel PIX shown in (a) of FIG. 1 in that (i) a plurality of pixel electrodes 52 are provided in place of the pixel electrodes 32A which belong to the type A of the pixel PIX and (ii) a plurality of pixel electrodes 53 are provided in place of the pixel electrodes 32B which belong to the type B of the pixel PIX. A total area of the plurality of pixel electrodes 52 and that of the plurality of pixel electrodes 53 satisfy a ratio of one to one. The plurality of pixel electrodes 52 and 53 are provided so that a slit is provided between respective ones of the plurality of pixel electrodes 52 and 53 which ones are adjacent to each other in turn in a line direction. The slits extend so as to be at an angle of 45 degrees for MVA driving use. The plurality of pixel electrodes 52 are connected with each other via a connecting electrode 52a, and the plurality of pixel electrodes 53 are connected with each other via a connecting electrode 53a, above a storage electrode bus line CSL. Ones of the pixel electrodes 52 and 53 are connected to the TFT 30 via contact holes 31A and 31B, respectively. Common electrodes are separately provided for each of the pixel electrodes 52 and 53. The common electrodes have respective slits and are driven in accordance with a PVA mode.

(b) of FIG. 9 is a cross sectional view of the pixel PIX1 taken along the line E-E′ of (a) of FIG. 9.

The pixel PIX1 has an arrangement in which a VA liquid crystal layer LC is provided between a TFT substrate 63 and a common substrate 64. The TFT substrate 63 is arranged so that (i) a pixel electrode 52 made of a transparent electrode of the type A, (ii) a pixel electrode 53 made of a transparent electrode of the type B, and (iii) a VA alignment film 60 are provided in this order on the transparent insulating film 49 shown in (c) of FIG. 1. The common substrate 64 is arranged so that (i) a color filter 72 and a black matrix 73, (ii) a passivation film 74, (iii) common electrodes 77 and 78 made of transparent electrodes, and (iv) a VA alignment film 76 are provided, in this order, on a glass substrate 71. The common electrodes 77 and 78 are provided for the pixel electrodes 52 and 53, respectively, and receive common voltages VcA and VcB, respectively.

(a) of FIG. 10 illustrates a transmittance characteristic of the pixel PIXr viewed in a direction which is at an azimuth angle of 45 degrees with the line direction. (b) of FIG. 10 is a magnified graph illustrating the transmittance characteristics each in a range of viewing angles from 40 degrees to 70 degrees. (b) of FIG. 10 shows that grayscale inversions, which occur at a viewing angles which are short of around 60 degrees and more, do not become so large as the comparative example 1. This shows that a viewing angle of the pixel PIX1 is greater than that of the pixel PIXr.

### Example 2

(a) of FIG. 11 is a plane view illustrating a schematic structure of a pixel PIX2 which is an example of the pixel PIX. The pixel PIX2 is different from the pixel PIX shown in (a) of FIG. 1 in that (i) a plurality of pixel electrodes 54 are provided in place of the pixel electrodes 32A which belong to the type A of the pixel PIX and (ii) a plurality of pixel electrodes 55 are provided in place of the pixel electrodes 32B which belong to the type B of the pixel PIX. A total area of the plurality of pixel electrodes 54 and that of the plurality of pixel electrodes 55 satisfy a ratio of one to two. The pixel electrodes 54 and 55 are provided so that a slit is provided between respective ones of the plurality of pixel electrodes 54 and 55 which ones are adjacent to each other in a line direction. The slits extend so as to be at an angle of 45 degrees for MVA driving use. The pixel electrodes 54 are connected with each other via a connecting electrode 54a, and the pixel electrodes 55 are connected with each other via a connecting electrode 55a, above a storage electrode bus line CsL. Ones of the plurality of pixel electrodes 54 and 55 are connected to the TFT 30 via contact holes 31A and 31B, respectively. Common electrodes are separately provided for each of the pixel electrode 54 and 55. Each of the common electrodes has a slit and is driven in accordance with a PVA mode.

(b) of FIG. 11 is a cross sectional view of the pixel PIX2 taken along the line F-F′ of (a) of FIG. 11.

The pixel PIX2 has an arrangement in which a VA liquid crystal layer LC is provided between a TFT substrate 65 and a common substrate 66. The TFT substrate 65 is arranged so that (i) a pixel electrode 54 made of a transparent electrode of the type A, (ii) a pixel electrode 55 made of a transparent electrode of the type B, and (iii) a VA alignment film 60 are provided, in this order, on the transparent insulating film 49 shown in (c) of FIG. 1. The common substrate 66 is arranged so that (i) a color filter 72 and a black matrix 73, (ii) a passivation film 74, (iii) common electrodes 79 and 80 made of transparent electrodes, and (iv) a VA alignment film 76 are provided, in this order, on a glass substrate 71. The common electrodes 79 and 80 are provided for the pixel electrodes 54 and 55, respectively, and receive common voltages VcA and VcB, respectively.

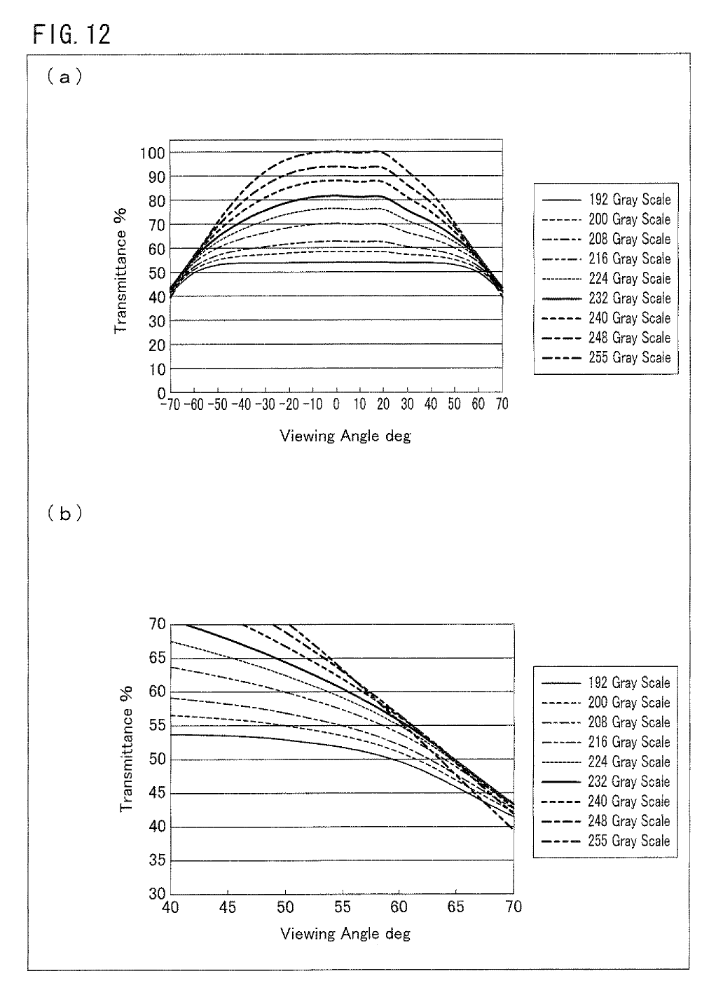

(a) of FIG. 12 illustrates a transmittance characteristic of the pixel PIXr viewed in a direction which is at an azimuth angle of 45 degrees with the line direction. (b) of FIG. 12 is a magnified graph illustrating the transmittance characteristics each in a range of viewing angles from 40 degrees to 70 degrees. (b) of FIG. 12 shows that grayscale inversions become smaller than those of Example 1. It follows that the pixel PIX2 has a wider viewing angle than the pixel PIX1.

### Example 3

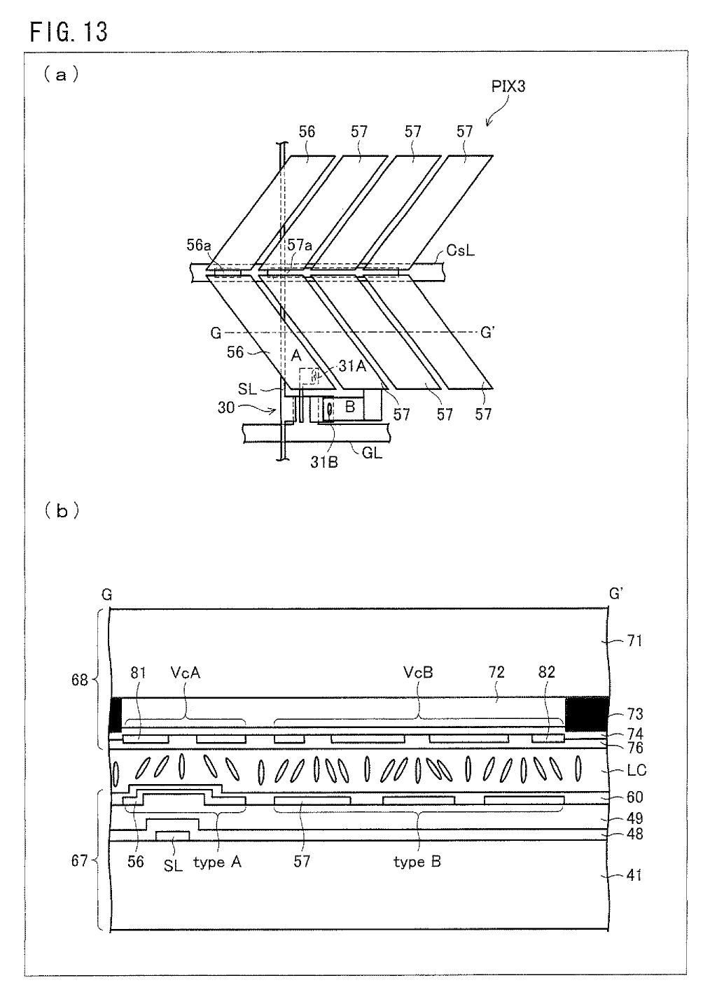

(a) of FIG. 13 is a plane view illustrating a schematic structure of a pixel PIX3 which is an example of the pixel PIX. The pixel PIX3 is different from the pixel PIX shown in (a) of FIG. 1 in that (i) a plurality of pixel electrodes 56 are provided in place of the pixel electrodes 32A which belong to the type A of the pixel PIX and (ii) a plurality of pixel electrodes 57 are provided in place of the pixel electrodes 32B which belong to the type B of the pixel PIX. A total area of the plurality of pixel electrodes 56 and that of the plurality of pixel electrodes 57 satisfy a ratio of one to three. The pixel electrodes 56 and 57 are provided so that a slit is provided between respective ones of the plurality of pixel electrodes 56 and 57 which ones are adjacent to each other in a line direction. The slits extend so as to be at an angle of 45 degrees for MVA driving use. The pixel electrodes 56 are connected with each other via a connecting electrode 56a, and the plurality of pixel electrodes 57 are connected with each other via a connecting electrode 57a, above a storage electrode bus line CsL. Ones of the plurality of pixel electrodes 56 and 57 are connected to the TFT 30 via contact holes 31A and 31B, respectively. Common electrodes are separately provided for each of the pixel electrodes 56 and 57. Each of the common electrodes has a slit and is driven in accordance with the PVA mode.

(b) of FIG. 13 is a cross sectional view of the pixel PIX3 taken along the line G-G′ of (a) of FIG. 13.

The pixel PIX2 has an arrangement in which a VA liquid crystal layer LC is provided between a TFT substrate 67 and a common substrate 68. The TFT substrate 67 is arranged so that (i) a pixel electrode 56 made of a transparent electrode of the type A, (ii) a pixel electrode 57 made of a transparent electrode of the type B, and (iii) a VA alignment film 60 are provided, in this order, on the transparent insulating film 49 shown in (c) of FIG. 1. The common substrate 68 is arranged so that (i) a color filter 72 and a black matrix 73, (ii) a passivation film 74, (iii) common electrodes 81 and 82 made of transparent electrodes, and (iv) a VA alignment film 76 are provided, in this order, on a glass substrate 71. The common electrodes 81 and 82 are provided for the pixel electrodes 56 and 57, respectively, and receive common voltages VcA and VcB, respectively.

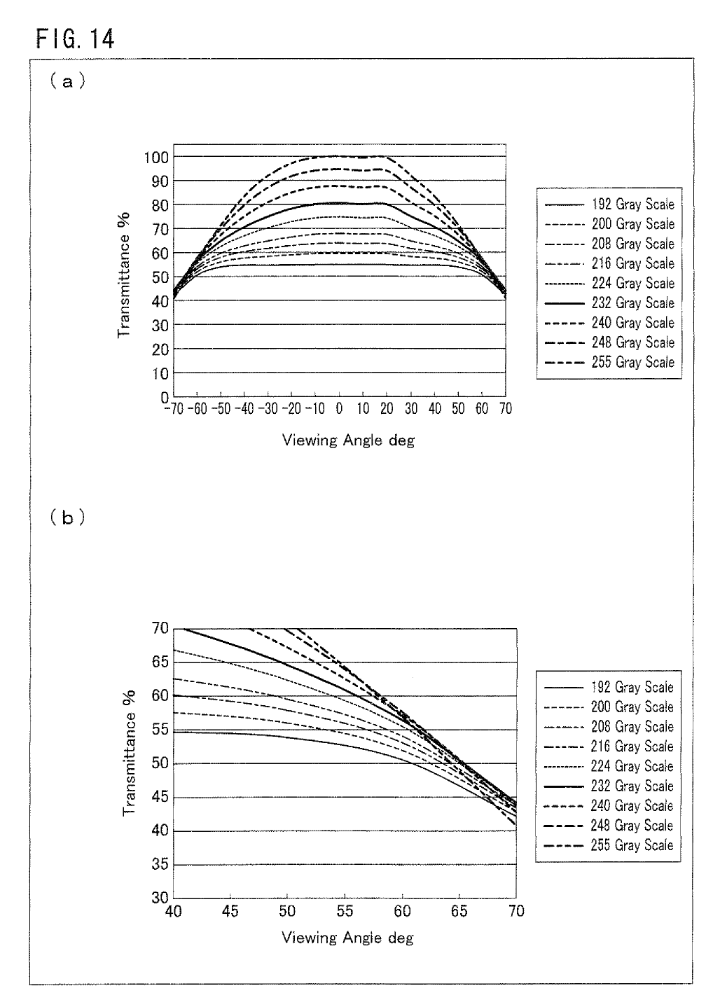

(a) of FIG. 14 illustrates a transmittance characteristic of the pixel PIXr viewed in a direction which is at an azimuth angle of 45 degrees with the line direction. (b) of FIG. 14 is a magnified graph illustrating the transmittance characteristics each in a range of viewing angles from 40 degrees to 70 degrees. As with Example 2, (b) of FIG. 14 shows that grayscale inversions become smaller than that of Example 1. It follows that a viewing angle of the pixel PIX3 is greater than that of the pixel PIX1.

### Example 4

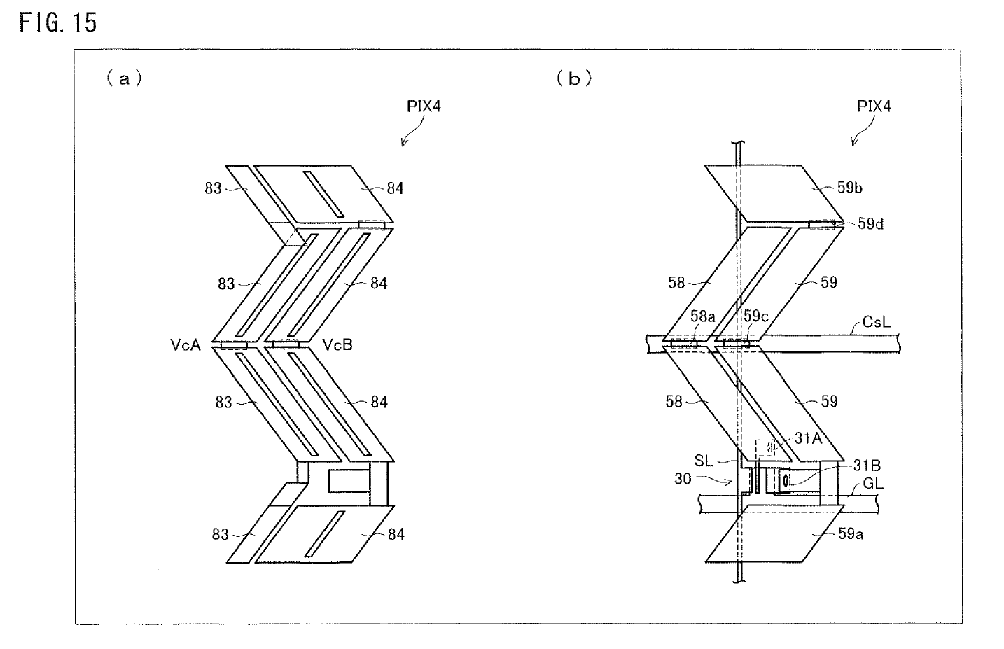

(a) and (b) of FIG. 15 are plane views illustrating a schematic structure of a pixel PIX4 which is an example of the pixel PIX. (a) of FIG. 15 is a plane view illustrating a pattern of a common electrode, and (b) of FIG. 15 is a plane view illustrating a pattern of a TFT substrate.

As shown in (b) of FIG. 15, the pixel PIX4 is different from the pixel PIX shown in (a) of FIG. 1 in that (i) a plurality of pixel electrodes 58 are provided in place of the pixel electrodes 32A which belong to the type A of the pixel PIX and (ii) a plurality of pixel electrodes 59, 59a, and 59b are provided in place of the pixel electrodes 32B which belong to the type B of the pixel PIX. A total area of the plurality of pixel electrodes 58 and that of the plurality of pixel electrodes 59, 59a, and 59b satisfy a ratio of one to two. The plurality of pixel electrodes 58 and 59 are provided so that a slit is provided between respective ones of the plurality of pixel electrodes 51 which ones are adjacent to each other in a line direction. The slits extend so as to be at an angle of degrees for MVA driving use. The plurality of pixel electrodes 58 are connected with each other via a connecting electrode 58a, and the plurality of pixel electrodes 59 are connected with each other via a connecting electrode 59c, above a storage electrode bus line CsL. Ones of the pixel electrodes 58 and 59 are connected to the TFT 30 via contact holes 31A and 31B, respectively.

Each of the pixel electrodes 59a is provided on a TFT 30 side of a column direction with respect to each of the pixel electrodes 59. Each of the pixel electrode 59b is provided on a side opposite to the TFT 30 side of a column direction with respect to each of the pixel electrodes 59. The pixel electrode 59a is connected to the TFT 30 via the contact hole 31B, and the pixel electrode 59b is connected to the pixel electrode 59 via a connecting electrode 59d. The pixel electrodes 59a and 59b have respective edges obliquely extending at an angle same as those of the slits provided between the pixel electrodes 58 and 59.

As shown in (b) of FIG. 15, a common electrode is constituted by a common electrode 83 and a common electrode 84 each of which is made of a transparent electrode. The common electrode 83 is provided for the pixel electrodes 58, and receives a common voltage VcA. The common electrode 84 is provided for the pixel electrodes 59, 59a, and 59b, and receive a common voltage VcB. Each of the common electrodes has a slit, and is driven in accordance with the PVA mode.

Note that, in the present embodiment, the ratio of the total area of the pixel electrodes 58 to the total area of the pixel electrodes 59, 59a, and 59b is not limited to the ratio of one to two, but may be set arbitrarily.

The above description discussed the Examples of the pixel PIX.

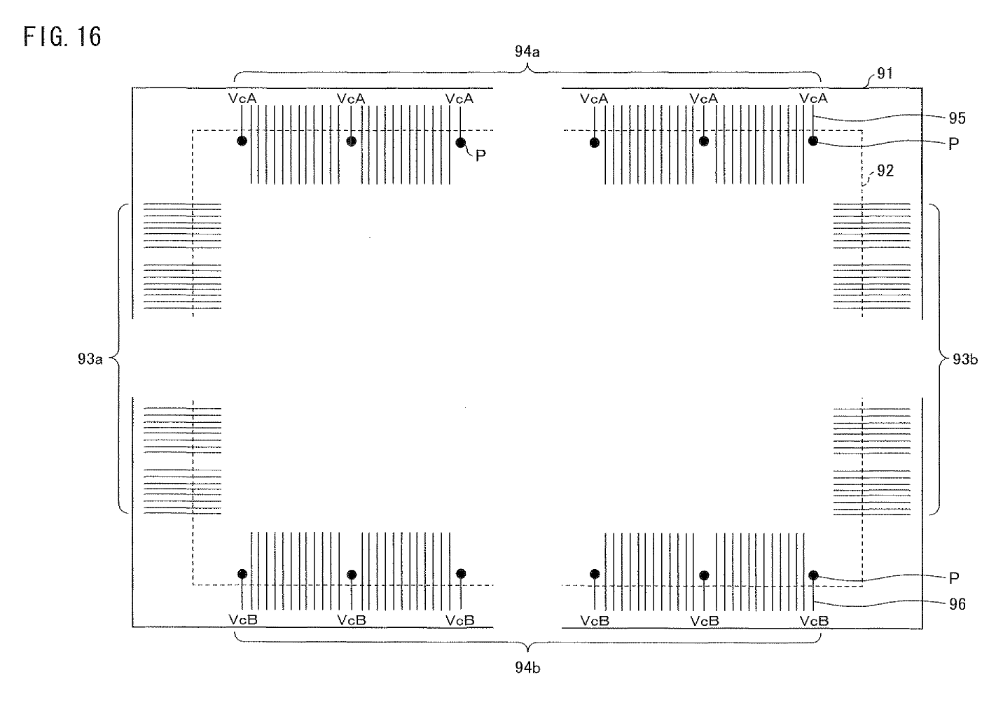

The following describes, with reference to FIGS. 16 through 18, various types of wiring arrangements for applying voltages to respective common electrodes provided so as to correspond to the type A and the type B of pixel electrodes. According to each of the arrangements, in a liquid crystal display panel in which a TFT substrate (matrix substrate) 91 and a common substrate 92 which has a size smaller than that of the TFT substrate 91 are combined so as to be positioned at their centers, (i) first scan wiring input terminals 93a and second scan wiring input terminals 93b on a second side opposite to a first side of the TFT substrate 91 on which first side the first scan wiring input terminals are provided are provided so that a display section 100 is provided between them and (ii) first data wiring input terminals 94a and second data wiring input terminals 94b on a second side opposite to a first side of the TFT substrate 91 on which first side the first data wiring input terminals are provided are provided so that the display section 100 is provided between them. Note, however, that the wiring arrangement is not limited to the above described arrangement. For example, the first and second scan wiring input terminals can be provided only on one of the first and second sides of the TFT substrate 91. Similarly, the first and second data wiring input terminals can be provided only on one of the first and second sides of the TFT substrate 91.

FIG. 16 illustrates an arrangement in which, a plurality of wires 95, through which a common voltage VcA is supplied, (i) are provided on the same side as the data wiring input terminal 94a and (ii) are routed around from the TFT substrate 91 toward the common substrate 92. Moreover, in the arrangement, a plurality of wires 96, through which a common voltage VcB is supplied, (i) are provided on the same side as the data wiring input terminal 94b and (ii) are routed around from the TFT substrate 91 toward the common substrate 92. The plurality of wires 95 and the plurality of wires 96 are connected to the common substrate 91, via a conductive material such as carbon paste, silver paste, or a conductive spacer, as illustrated, by points P of FIG. 16.

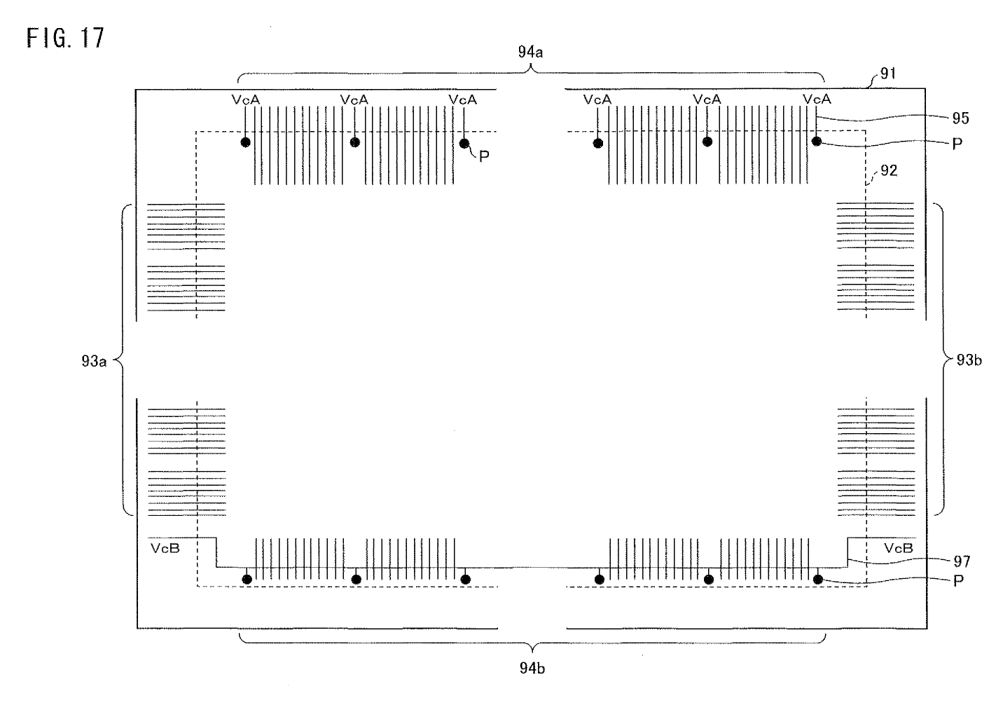

FIG. 17 illustrates an arrangement in which a plurality of wires 95, through which a common voltage VcA is supplied, (i) are provided on the same side as the data wiring input terminal 94a and (ii) are routed around from the TFT substrate 91 toward the common substrate 92. Moreover, in the arrangement, a wire 97, through which a common voltage VcB is supplied, (i) is provided on the same side as the scan wiring input terminals 93a and 93b and (ii) is routed around from the TFT substrate 91 toward the common substrate 92. The wire 97 (i) is routed around a region, which is closer to edges of the data wiring input terminal 94b on the TFT substrate 91 which edges are below the common substrate 91, and (ii) is then branched into a plurality of wires so as to be connected to the common electrode 92. The plurality of wires 95 and the wire 97 are connected to the common substrate 91, via a conductive material such as carbon paste, silver paste, or a conductive spacer, as illustrated by points P of FIG. 17.

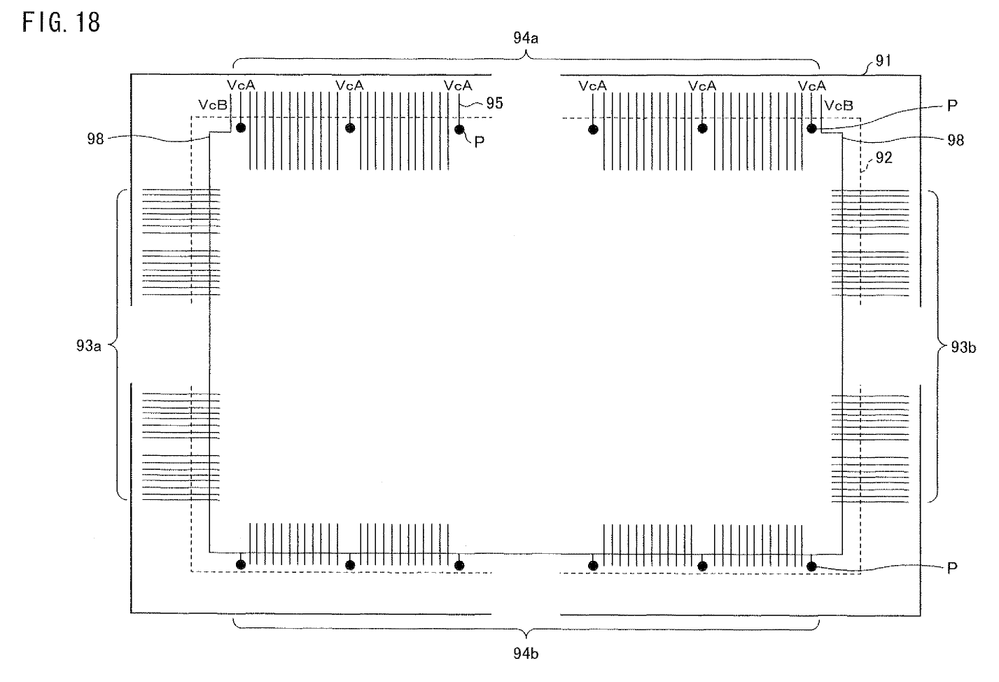

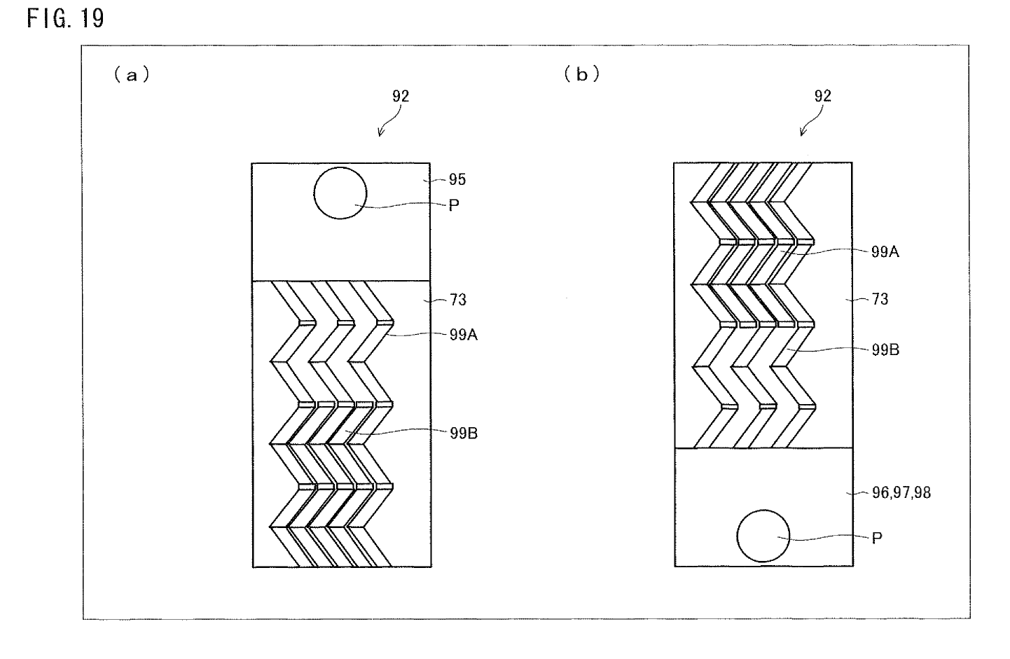

FIG. 18 illustrates an arrangement in which a plurality of wires 95, through which a common voltage VcA is supplied, (i) are provided on the same side as the data wiring input terminal 94a and (ii) are routed around from the TFT substrate 91 toward the common substrate 92. Moreover, in the arrangement, a wire 98, through which a common voltage VcB is supplied, (i) is provided on the same side as the data wiring input terminal 94a and (ii) are routed around from the TFT substrate 91 toward the common substrate 92. The wire 98 is routed around each region which is closer to edges of (i) the scan wiring input terminal 93a, (ii) the data wiring input terminal 94b, (iii) the scan wiring input terminal 93b, and (iv) the data wiring input terminal 94b on the TFT substrate 91 which edges are below the common substrate 91. Further, the wire 98 is then branched into a plurality of wires so as to be connected to the common electrode 92. The plurality of wires 95 and the wire 98 are connected to the common substrate 91, via a conductive material such as carbon paste, silver paste, or a conductive spacer, as illustrated by P of FIG. 18.

(a) and (b) of FIG. 19 illustrate patterns of a region where the common electrode and the wires for applying the common voltage which are discussed with reference to FIGS. 16 through 18.

(a) of FIG. 19 illustrates a pattern of a region where a common electrode 99A and the wire 95 through which a common voltage VcA is supplied are connected with each other. The wire 95 from the TFT substrate 91 is (i) connected to the common substrate 92 at the point P via a conductive material, (ii) terminated in a pattern in parallel with an edge of the common substrate 92, and (iii) connected to an edge of the common electrode 99A at the pattern in parallel with the edge of the common substrate 92.

(b) of FIG. 19 illustrates a pattern of a region where a common electrode 99B and the wires 96, 97, or 98 through which a common voltage VcB is supplied are connected with each other. The wires 96, 97, or 98 from the TFT substrate 91 is (i) connected to the common substrate 92 at the point P via a conductive material, (ii) terminated at a pattern along an edge of the common substrate 92, and (iii) connected to an edge of the common electrode 99B at the pattern along the edge of the common substrate 92.

The following describes an AC driving of the liquid crystal display device 1 of the present embodiment.

The liquid crystal display device 1 is capable of carrying out either a source bus line inversion driving or a dot inversion driving in any of Examples.

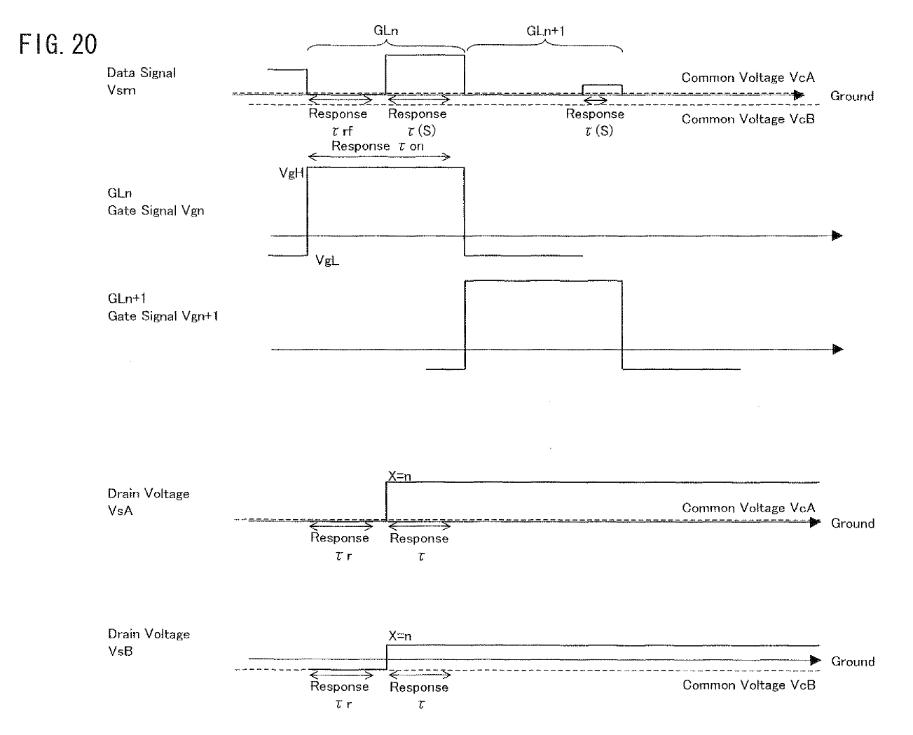

FIG. 20 illustrates signal waveforms in the source bus line inversion driving. A data signal Vsm which has an identical polarity in each horizontal period is outputted via a single source bus line. Data signals Vsm having respective opposite polarities are supplied to any adjacent ones of the plurality of source bus lines. In FIG. 20, signals are illustrated in a case of a source bus line during a frame having a positive polarity. Accordingly, the data signal Vsm has a voltage higher than each of common voltages VcA and VcB. A pixel PIX connected to an n-th gate bus line GL is selected by a gate signal Vgn, and a drain voltage VsA of the type A and a drain voltage VsB of the type B are determined in accordance with a data signal Vsm obtained when the n-th gate bus line GL is selected. Then, different voltages of the respective types A and B are held until a next frame. Each of τ(S), τrf, τon, τ, and τr appended to signal waveforms in FIG. 20 indicates a charging/discharging response time.

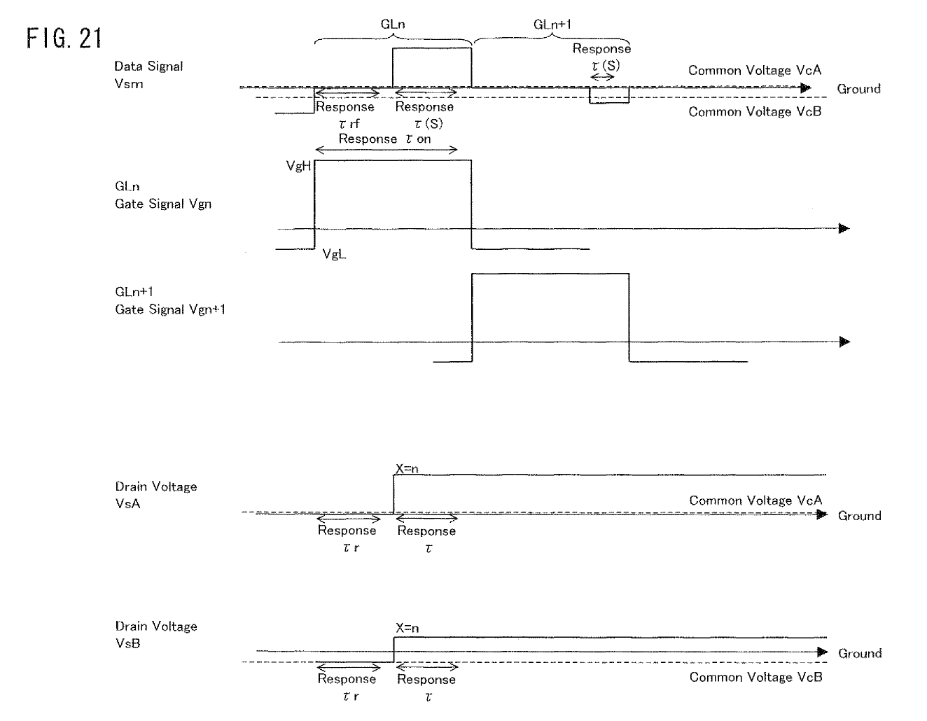

FIG. 21 illustrates signal waveforms in the dot inversion driving. A data signal Vsm which has an inverted polarity in each horizontal period is outputted via a single source bus line. Data signals Vsm having respective opposite polarities are supplied to any adjacent ones of the plurality of source bus lines. In FIG. 21, signals are illustrated in a case of a source bus line during a horizontal period having a positive polarity. Accordingly, the data signal Vsm has a voltage higher than each of common voltages VcA and VcB. In a negative polar horizontal period, the data signal Vsm has a voltage lower than each of the common voltages VcA and VcB. A pixel PIX connected to an n-th gate bus line GL is selected by a gate signal Vgn. A drain voltage VsA of the type A and a drain voltage VsB of the type B are determined in accordance with a data signal Vsm obtained when the n-th gate bus line GL is selected. Then, different voltages of the respective types A and B are held until a next frame. Each of τ(S), τrf, τon, τ, and τr appended to signal waveforms in FIG. 21 indicates a charging/discharging response time.

In FIGS. 20 and 21, timing of supplying a scan signal and timing of supplying a data signal are set so that a charging/discharging response time of each of the plurality of subpixels falls within a period during which a corresponding data signal is written into a corresponding pixel. This causes the subpixels to have respective different charging/discharging response times. Accordingly, it is possible for a charging/discharging response to be ended within the writing period of the data signal. This makes it possible to ultimately secure a target root mean square holding voltage.

The above description discussed the present embodiment. The field-effect transistor used as a selection element is not limited to a TFT but can be a field-effect transistor provided on a single crystalline substrate. Moreover, the number of the subpixels is not limited to a specific one.

The present invention is not limited to the description of the embodiments above, but can be altered by a skilled person in the art within the scope of the claims. An embodiment derived from a proper combination of technical means disclosed in respective different embodiments is also encompassed in the technical scope of the present invention. As described above, the display device of the present invention is an active matrix display device, including: a pixel which includes a plurality of subpixels; and a single field-effect transistor which (i) serves as a selection element and (ii) carries out selection or non-selection with respect to each of the plurality of subpixels, parts of a channel forming region which are used as charging/discharging paths for the respective plurality of subpixels having lengths different from each other, by arranging the plurality of subpixels so that at least one of them is connected to a conductive path which branches off and is drawn out from the channel forming region of the field-effect transistor, and common electrodes being provided for the respective plurality of subpixels so as to be electrically separated from each other. As described above, the driving method of the present invention is a driving method of an active matrix display device including: a pixel which includes a plurality of subpixels; and a single field-effect transistor which (i) serves as a selection element and (ii) carries out selection or non-selection with respect to each of the plurality of subpixels, parts of a channel forming region which are used as charging/discharging paths for the respective plurality of subpixels having lengths different from each other, by arranging the plurality of subpixels so that at least one of them is connected to a conductive path which branches off and is drawn out from the channel forming region of the field-effect transistor, and common electrodes being provided for the respective plurality of subpixels so as to be electrically separated from each other, said driving method including the step of: supplying bias voltages to the respective common electrodes provided for the respective plurality of subpixels.

The configuration described above makes it possible to realize (i) a display device which can achieve an easy drive and less number of components, in spite of a single pixel including a plurality of subpixels, and (ii) a driving method of such a display device.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

The present invention is suitably applicable to a liquid crystal display device.

1. An active matrix display device, comprising:
a pixel which includes a plurality of subpixels; and
a single field-effect transistor which (i) serves as a selection element and (ii) carries out selection or non-selection with respect to each of the plurality of subpixels,
parts of a channel forming region which are used as charging/discharging paths for the respective plurality of subpixels having lengths different from each other, by arranging the plurality of subpixels so that at least one of them is connected to a conductive path which branches off and is drawn out from the channel forming region of the field-effect transistor, and
common electrodes being provided for the respective plurality of subpixels so as to be electrically separated from each other.

2. A display device as set forth in claim 1, further comprising a single storage capacitor line which is shared by the plurality of subpixels.

3. The display device as set forth in claims 1 to 2, wherein the common electrodes receive respective different bias voltages which differ between the plurality of subpixels.

4. The display device as set forth in claim 1, wherein:
timing of supplying a scan signal and timing of supplying a data signal are set so that the plurality of subpixels have respective charging/discharging response times which fall within a period during which a corresponding data signal is written into the pixel.

5. The display device as set forth in claim 1, wherein:
the plurality of subpixels are made up of a first subpixel and a second subpixel, and a ratio of a pixel electrode area of the first subpixel to a pixel electrode area of the second subpixel is set to a ratio of one to one.

6. The display device as set forth in claim 1, wherein:
the plurality of subpixels are made up of a first subpixel and a second subpixel, and a ratio of a pixel electrode area of the first subpixel to a pixel electrode area of the second subpixel is set to a ratio of one to two.

7. The display device as set forth in claim 1, wherein:
the plurality of subpixels are made up of a first subpixel and a second subpixel, and a ratio of a pixel electrode area of the first subpixel to a pixel electrode area of the second subpixel is set to a ratio of one to three.

8. A display device as set forth in claim 1, wherein:
wires, through which respective bias voltages are supplied to the common electrodes provided for the respective plurality of subpixels, are connected toward a common substrate from a same side on a matrix substrate as a side on which input terminals for lines related to data signals are provided.

9. The display device as set forth in claim 8, wherein:
the input terminals are made up of first and second input terminals between which a display section is provided;
the plurality of subpixels are made up of a first subpixel and a second subpixel, the bias voltages are made up of first and second bias voltages, the common electrodes are made up of first and second common electrodes, and the wires are made up of first and second wires;
the first wire through which the first bias voltage is applied to the first common electrode is connected toward the first common electrode of the first subpixel from a same first side as a side on which the first input terminals of the first line related to the data signal are provided; and
the second wire through which the second bias voltage is applied to the second common electrode is connected toward the second common electrode of the second subpixel from a same second side as a side on which the second input terminals of the second line related to the data signal are provided.

10. The display device as set forth in claim 9, wherein:
the second wire (i) is routed around on the matrix substrate from the first side toward the second side, and (ii) is then connected toward the second common electrode.

11. The display device as set forth in claim 1, wherein:
respective bias voltages are supplied to the common electrodes provided for the respective plurality of subpixels through wires,
at least one of the wires being connected toward a common substrate from a same side on a matrix substrate as a side on which input terminals for lines related to data signals are provided, and
the other of the wires being connected toward the common substrate from a same side on the matrix substrate as a side on which input terminals for lines related to scan signals are provided.

12. A driving method of an active matrix display device comprising:
a pixel which includes a plurality of subpixels; and
a single field-effect transistor which (i) serves as a selection element and (ii) carries out selection or non-selection with respect to each of the plurality of subpixels,
parts of a channel forming region which are used as charging/discharging paths for the respective plurality of subpixels having lengths different from each other, by arranging the plurality of subpixels so that at least one of them is connected to a conductive path which branches off and is drawn out from the channel forming region of the field-effect transistor, and
common electrodes being provided for the respective plurality of subpixels so as to be electrically separated from each other,
said driving method comprising the step of:
supplying bias voltages to the respective common electrodes provided for the respective plurality of subpixels.

13. A driving method as set forth in claim 12, further comprising the step of:
causing storage capacitor voltages corresponding to the respective plurality of subpixels to be equal to each other.

14. A driving method as set forth in claim 12, further comprising the step of:
setting timing of supplying a scan signal and timing of supplying a data signal so that the plurality of subpixels have respective charging/discharging response times which fall within a period during which a corresponding data signal is written into the pixel.

15. The driving method as set forth in claim 12 in which a source bus line inversion driving is carried out.

16. The driving method as set forth in claim 12 in which a dot inversion driving is carried out.
